(19) United States
(12) Patent Application Publication
(10) Pub. No.: US 2026/0267476 A1
(43) Pub. Date: Sep. 10, 2026

(54) SYSTEM AND METHOD FOR GENERATION OF A GRAPHICAL USER INTERFACE FOR INCREMENTAL DATA PROCESSING

(71) Applicant: Shan Jiang, Richmond Hill (CA)

(72) Inventor: Shan Jiang, Richmond Hill (CA)

(73) Assignee: Shan Jiang, Richmond Hill (CA)

(21) Appl. No.: 19/074,839

(22) Filed: Mar. 10, 2025

(51) Int. Cl. G06F 3/0483; G06F 3/04845

(52) U.S. Cl. CPC G06F 3/0483; G06F 3/04845

(57) ABSTRACT

A system for generation of a graphical user interface for incremental data processing, the system including a computing device configured to generate a graphical user interface including an incremental input element, receive one or more incremental data entries, generate a unique identifier for each incremental data entry, generate a journal entry for each incremental data entry of the one or more incremental data entries wherein each journal entry includes one or more matrix identifiers and one or more associated matrix values, present the one or more journal entries through the graphical user interface for authorization and append the one or more journal entries to a general ledger as a function of the authorization.

### FIELD OF THE INVENTION

The present invention generally relates to the field of graphical user interfaces for data processing. In particular, the present invention is directed to a system and method for generation of a graphical user interface for incremental data processing.

### BACKGROUND

Processing large volumes of data at once can lead to computer processing overload and thus result in inaccuracies. In addition, processing large volumes of data at once may result in data that has not been carefully reviewed for inaccuracy. Current systems lack the capabilities to implement incremental data processing such that large volumes of data may be incrementally processed thereby increasing computational efficiency and increasing operational oversight.

### SUMMARY OF THE DISCLOSURE

In an aspect, a system for generation of a graphical user interface for incremental data processing is described. The system includes at least a processor, and a memory communicatively connected to the processor. The memory contains instructions configuring the at least a processor to generate a graphical user interface including an incremental input element, receive one or more incremental data entries from one or more users through the incremental input element of the graphical user interface, generate a unique identifier for each incremental data entry of the one or more incremental data entries, generate a journal entry for each incremental data entry of the one or more incremental data entries wherein each journal entry includes one or more matrix identifiers and one or more associated matrix values, present the one or more journal entries through the graphical user interface for authorization wherein presenting the one or more journal entries through the graphical user interface includes populating a user interface data structure with the one or more matrix values using the one or more matrix identifiers and modifying the graphical user interface as a function of the user interface data structure and append the one or more journal entries to a general ledger as a function of the authorization.

In another aspect, a method for generation of a graphical user interface for incremental data processing is described. The method includes generating by at least a processor, a graphical user interface including an incremental input element. The method further includes, receiving, by the at least a processor, one or more incremental data entries from one or more users through the incremental input element of the graphical user interface, generating, by the at least a processor, a unique identifier for each incremental data entry of the one or more incremental data entries, generating, by the at least a processor, a journal entry for each incremental data entry of the one or more incremental data entries wherein each journal entry includes one or more matrix identifiers and one or more associated matrix values, presenting, by the at least a processor, the one or more journal entries through the graphical user interface for authorization wherein presenting the one or more journal entries through the graphical user interface includes populating, a user interface data structure with the one or more matrix values using the one or more matrix identifiers and modifying the graphical user interface as a function of the user interface data structure and appending, by the at least a processor, the one or more journal entries to a general ledger as a function of the authorization.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram illustrating an exemplary embodiment of a system for incremental data processing;

FIG. 2 is an exemplary flow diagram for generating data files;

FIGS. 3A-3B are exemplary embodiments of a graphical view;

FIG. 4 is a block diagram of exemplary embodiment of a chatbot;

FIG. 5 is a block diagram of exemplary embodiment of a machine learning module;

FIG. 6 is a diagram of an exemplary embodiment of a neural network;

FIG. 7 is a block diagram of an exemplary embodiment of a node of a neural network;

FIG. 8 is a flow diagram illustrating an exemplary embodiment of a method for incremental data processing; and

FIG. 9 is a block diagram of a computing system that can be used to implement any one or more of the methodologies disclosed herein and any one or more portions thereof. The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for incremental data processing. In an embodiment, aspects of the present disclosure include a computing device and a graphical user interface. In an aspect, the computing device is configured to receive incremental data entries, generate journal entries for each incremental data entry and append the journal entries to a general ledger.

Aspects of the present disclosure can be used to process information incrementally in order to produce a singular result. Aspects of the present disclosure can also be used to increase computational efficiency by reducing a dimensionality of inputs. Exemplary embodiments illustrating aspects of the present disclosure are described below in the context of several specific examples.

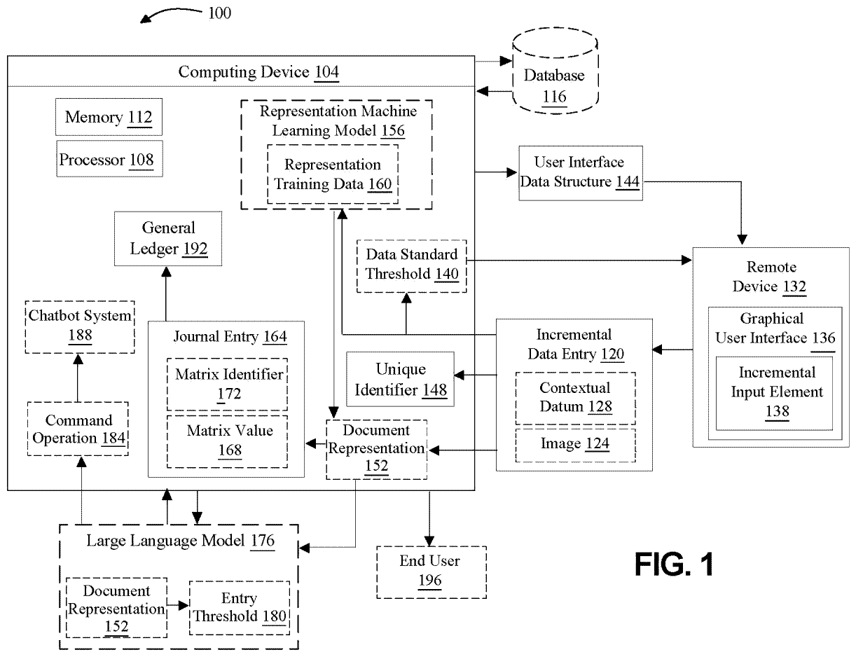

Referring now to FIG. 1, a system 100 for incremental data processing is described. System 100 includes a computing device 104. System 100 includes a processor 108. Processor 108 may include, without limitation, any processor 108 described in this disclosure. Processor 108 may be included in a and/or consistent with computing device 104. In one or more embodiments, processor 108 may include a multi-core processor. In one or more embodiments, multi-core processor may include multiple processor cores and/or individual processing units. “Processing unit” for the purposes of this disclosure is a device that is capable of executing instructions and performing calculations for a computing device 104. In one or more embodiments, processing units may retrieve instructions from a memory, decode the data, secure functions and transmit the functions back to the memory. In one or more embodiments, processing units may include an arithmetic logic unit (ALU) wherein the ALU is responsible for carrying out arithmetic and logical operations. This may include, addition, subtraction, multiplication, comparing two data, contrasting two data and the like. In one or more embodiments, processing unit may include a control unit wherein the control unit manages execution of instructions such that they are performed in the correct order. In none or more embodiments, processing unit may include registers wherein the registers may be used for temporary storage of data such as inputs fed into the processor and/or outputs executed by the processor. In one or more embodiments, processing unit may include cache memory wherein memory may be retrieved from cache memory for retrieval of data. In one or more embodiments, processing unit may include a clock register wherein the clock register may be configured to synchronize the processor with other computing components. In one or more embodiments, processor 108 may include more than one processing unit having at least one or more arithmetic and logic units (ALUs) with hardware components that may perform arithmetic and logic operations. Processing units may further include registers to hold operands and results, as well as potentially “reservation station” queues of registers, registers to store interim results in multi-cycle operations, and an instruction unit/control circuit (including e.g. a finite state machine and/or multiplexor) that reads op codes from program instruction register banks and/or receives those op codes and enables registers/arithmetic and logic operators to read/output values. In one or more embodiments, processing unit may include a floating-point unit (FPU) wherein the FPU may be configured to handle arithmetic operations with floating point numbers. In one or more embodiments, processor 108 may include a plurality of processing units wherein each processing unit may be configured for a particular task and/or function. In one or more embodiments, each core within multi-core processor may function independently. In one or more embodiments, each core within multi-core processor may perform functions in parallel with other cores. In one or more embodiments, multi-core processor may allow for a dedicated core for each program and/or software running on a computing system. In one or more embodiments, multiple cores may be used for a singular function and/or multiple functions. In one or more embodiments, multi-core processor may allow for a computing system to perform differing functions in parallel. In one or more embodiments, processor 108 may include a plurality of multi-core processors. Computing device 104 may include any computing device as described in this disclosure, including without limitation a microcontroller, microprocessor, digital signal processor (DSP) and/or system on a chip (SoC) as described in this disclosure. Computing device 104 may include, be included in, and/or communicate with a mobile device such as a mobile telephone or smartphone. Computing device 104 may include a single computing device 104 operating independently or may include two or more computing devices operating in concert, in parallel, sequentially or the like; two or more computing devices may be included together in a single computing device 104 or in two or more computing devices. Computing device 104 may interface or communicate with one or more additional devices as described below in further detail via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device 104. Computing device 104 may include but is not limited to, for example, a computing device 104 or cluster of computing devices in a first location and a second computing device 104 or cluster of computing devices in a second location. Computing device 104 may include one or more computing devices dedicated to data storage, security, distribution of traffic for load balancing, and the like. Computing device 104 may distribute one or more computing tasks as described below across a plurality of computing devices of computing device 104, which may operate in parallel, in series, redundantly, or in any other manner used for distribution of tasks or memory 112 between computing devices. Computing device 104 may be implemented, as a non-limiting example, using a “shared nothing” architecture.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, computing device 104 may perform determinations, classification, and/or analysis steps, methods, processes, or the like as described in this disclosure using machine-learning processes. A “machine-learning process,” as used in this disclosure, is a process that automatedly uses a body of data known as “training data” and/or a “training set” (described further below in this disclosure) to generate an algorithm that will be performed by a Processor module to produce outputs given data provided as inputs; this is in contrast to a non-machine learning software program where the commands to be executed are determined in advance by a user and written in a programming language. A machine-learning process may utilize supervised, unsupervised, lazy-learning processes and/or neural networks, described further below.

With continued reference to FIG. 1, system 100 includes a memory 112 communicatively connected to processor 108, wherein the memory 112 contains instructions configuring processor 108 to perform any processing steps as described herein. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, using a bus or other facility for intercommunication between elements of a computing device 104. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, memory 112 may include a primary memory and a secondary memory. “Primary memory” also known as “random access memory” (RAM) for the purposes of this disclosure is a short-term storage device in which information is processed. In one or more embodiments, during use of computing device 104, instructions and/or information may be transmitted to primary memory wherein information may be processed. In one or more embodiments, information may only be populated within primary memory while a particular software is running. In one or more embodiments, information within primary memory is wiped and/or removed after computing device 104 has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power. “Secondary memory” also known as “storage,” “hard disk drive” and the like for the purposes of this disclosure is a long-term storage device in which an operating system and other information is stored. In one or remote embodiments, information may be retrieved from secondary memory and transmitted to primary memory during use. In one or more embodiments, secondary memory may be referred to as non-volatile memory wherein information is preserved even during a loss of power. In one or more embodiments, data within secondary memory cannot be accessed by processor. In one or more embodiments, data is transferred from secondary to primary memory wherein processor 108 may access the information from primary memory.

Still referring to FIG. 1, system 100 may include a database 116. Database may include a remote database 116. Database 116 may be implemented, without limitation, as a relational database, a key-value retrieval database such as a NOSQL database, or any other format or structure for use as database that a person skilled in the art would recognize as suitable upon review of the entirety of this disclosure. Database may alternatively or additionally be implemented using a distributed data storage protocol and/or data structure, such as a distributed hash table or the like. Database 116 may include a plurality of data entries and/or records as described above. Data entries in database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in database may store, retrieve, organize, and/or reflect data and/or records.

With continued reference to FIG. 1, system 100 may include and/or be communicatively connected to a server, such as but not limited to, a remote server, a cloud server, a network server and the like. In one or more embodiments. In one or more embodiments, computing device 104 may be configured to transmit one or more processes to be executed by server. In one or more embodiments, server may contain additional and/or increased processor power wherein one or more processes as described below may be performed by server. For example, and without limitation, one or more processes associated with machine learning may be performed by network server, wherein data is transmitted to server, processed and transmitted back to computing device. In one or more embodiments, server may be configured to perform one or more processes as described below to allow for increased computational power and/or decreased power usage by system computing device 104. In one or more embodiments, computing device 104 may transmit processes to server wherein computing device 104 may conserve power or energy.

With continued reference to FIG. 1, one or more processes as described in this disclosure may be performed by server. In one or more embodiments, processor 108 may communicate with server to receive information needed for one or more instructions tasked by processor 108. In one or more embodiments, server may include one or more systems and/or software configured to provide information and/or data to processor 108. A “server” for the purposes of this disclosure is a system that provides resources, data or services to other computing systems over a network. For example, without limitation, server may include a web server, a file server, a database server, and/or the like.

With continued reference to FIG. 1, one or more processes as described in this disclosure may be performed by server. In one or more embodiments, processor 108 May communicate with server to receive information needed for one or more instructions tasked by processor 108. In one or more embodiments, server may include one or more systems and/or software configured to provide information and/or data to processor 108. A “server” for the purposes of this disclosure is a system that provides resources, data or services to other computing systems over a network. For example and without limitation, server may include a web server, a file server, a database 116 server, and/or the like.

With continued reference to FIG. 1, processor 108 is configured to receive one or more incremental data entries 120. An “incremental data entry” for the purposes of this disclosure refers to information that is added in small portions or sequential steps rather than all at once. For example, and without limitation, incremental data entry 120 may include a portion of a large data file, wherein the entire large data file may be received in increments. In one or more embodiments, incremental data entry 120 may include information that is received in increments, whereby all information may be needed to produce a singular output. For example, and without limitation, incremental data entries 120 may include numerical values, wherein the singular output may include a sum of said numerical values. In one or more embodiments, incremental data entry 120 may include any information that is transmitted in portions, rather than all at once. In one or more embodiments, incremental data entries 120 may include information that is readily available, whereby a singular output may be created once all information is received by processor 108. In some or more embodiments, incremental data entry may include textual data. In one or more embodiments, incremental data entry 120 may include information such as receipts, invoices, financial documents and/or the like that may be needed to generate an invoice, a financial statement and/or the like. In one or more embodiments, incremental data entry 120 may include receipts, purchase, images and/or the like needed to generate statements, processes financial documents and/or the like. In one or more embodiments, incremental data entries 120 may include costs of goods, rent, interest and/or the like that is needed to quantify the costs or revenue of a business or entity. In one or more embodiments, incremental data entry 120 may include information such as assets, liabilities, revenues, expenses, profits, cash flow, changes in equity, money owed, money due, operational budget, capital budget, payroll records and/or the like. In one or more embodiments, incremental data entry 120 may include any information that is submitted in portions and needed to produce a singular result.

With continued reference to FIG. 1, incremental data entry 120 may include one or more electronic documents. An “electronic document,” for the purposes of this disclosure, is a digital file. Electronic document may include, as non-limiting examples, an image, a PDF, a document, a word document, an image and document, text, a textual document, a combination of image, pdf, and/or text, and the like.

With continued reference to FIG. 1, in one or more embodiments, incremental data entry 120 may include at least an image. As used in this disclosure, an “image” or “image data” is information representing at least a physical scene, space, and/or object. In some cases, image data may be generated by a camera. “Image data” may be used interchangeably through this disclosure with “image,” where image 124 is used as a noun. An image 124 may be optical, such as without limitation where at least an optic is used to generate an image 124 of an object. An image 124 may be material, such as without limitation when film is used to capture an image. An image 124 may be digital, such as without limitation when represented as a bitmap. Alternatively, an image 124 may be comprised of any media capable of representing a physical scene, space, and/or object. Alternatively where “image” is used as a verb, in this disclosure, it refers to generation and/or formation of an image. In one or more embodiments, image 124 may include images of financial documents, images of receipts, images of financial information and/or the like. In one or more embodiments, image 124 may include a visual piece of information that is representative of incremental data entry 120. In one or more embodiments, image 124 may include source of a particular data entry. For example and without limitation, image 124 may provide a source for a particular debit that is owed. In one or more embodiments, image 124 may be captured by a camera. In one or more embodiments, image 124 may include a document such as a PDF. In one or more embodiments, image 124 may include any information that is not initially provided in a machine-readable format. In one or more embodiments, image 124 may include any information that is not received in a textual format. In one or more embodiments, image 124 may be received by a remote device 132 such as a smart phone, laptop, desktop computer and/or the like. In one or more embodiments, remote device 132 may include any computing system that is capable of transmitting image 124 to processor 108.

With continued reference to FIG. 1, incremental data entry 120 may include contextual datum 128 representative of image. “Contextual datum” for the purposes of this disclosure is information that is used to describe the contents of an image. For example, and without limitation, contextual datum 128 may indicate that the image 124 is a receipt, an invoice, a purchase order and/or the like. In one or more embodiments, contextual datum 128 may include information that may not be readily ascertainable when viewing image. For example, without limitation, contextual datum 128 may include information such as the date of the receipt within image, the individual who made the transaction, whether the information represented in the image 124 is of a credit owed or a debit owed, whether the image 124 is a of a receipt, an invoice, revenue, rent and/or the like. In one or more embodiments, contextual datum 128 may provide supplementary information that may allow for the content of image 124 to be properly processed. For example, without limitation, contextual datum 128 may indicate whether a payment was made as part of a settlement, as part of a business education expense, as part of a cost of goods and/or the like. In one or more embodiments, contextual datum 128 may include numerical values represented in image 124 such as but not limited to, a price indicated within image 124 and/or the like. In one or more embodiments, contextual datum 128 includes a processing request for image. A “processing request” for the purposes of this disclosure is instructions given to a system that indicates how a piece of data should be processed. For example, and without limitation, processing request may indicate that image 124 is a receipt, wherein a system may understand to process information within image 124 similar to how receipts are processed. In one or more embodiments, a system such as a machine learning model and/or a large language model may process differing information in differing ways. For example, and without limitation, a receipt may be processed in a first manner and an invoice may be processed in a second manner. In one or more embodiments, processing request may indicate to a system how the image 124 should be processed and/or extracted. In one or more embodiments, processing request may indicate to date image 124 to a particular day, to ignore certain bits of information within image, to provide more weight to certain portion of image 124 and/or the like. In one or more embodiments, processing request may further include instructions to a large language model on what particular output is desired. For example, without limitation, processing request may indicate a machine learning model to create a record within a financial transaction based on the image. In one or more embodiments, processing request may indicate to a large language model to process an image 124 as a credit and/or a debit.

With continued reference to FIG. 1, incremental data entries 120 are received by one or more users. A “user” for the purposes of this disclosure is an individual that is responsible for transmission of an incremental data entry 120. For example, and without limitation, user may include an employee working at a company, wherein the employee seeks to be reimbursed for a particular receipt. In one or more embodiments, user may include an individual who is responsible for the generation of image, for the purchase of a product that is indicated within image 124 and/or the like. In one or more embodiments, user may include any individual interacting with system 100 in order to input incremental data entry 120. In one or more embodiments, incremental data entries 120 may be received by a plurality of users wherein each user may be responsible for one or more incremental data entries 120 of a plurality of incremental data entries 120. In one or more embodiments, processor 108 may be configured to aggregate incremental data entries 120 to generate a singular output. In one or more embodiments, processor 108 may receive a plurality of incremental data entries 120 from a plurality of remote devices, wherein each remote device 132 is associated with a differing user. In one or more embodiments, each user may input an incremental data entry 120 into system 100, wherein system 100 may be configured to process incremental data entry 120.

With continued reference to FIG. 1, system includes a graphical user interface. For the purposes of this disclosure, a “user interface” is a means by which a user and a computer system interact. For example, through the use of input devices and software. In some cases, processor 108 may be configured to modify graphical user interface as a function of a user interface data structure 144. As used in this disclosure, “user interface data structure” is a data structure representing a specialized formatting of data on a computer configured such that the information can be effectively presented for a user interface. In one or more embodiments, user interface data structure 144 may include any information as described in this disclosure. User interface data structure 144 is described in more detail below. A user interface may include graphical user interface, command line interface (CLI), menu-driven user interface, touch user interface, voice user interface (VUI), form-based user interface, any combination thereof and the like. In some embodiments, a user may interact with the user interface using a computing device 104 distinct from and communicatively connected to processor 108. For example, remote device 132 such as a smart phone, smart tablet, or laptop operated by the user and/or participant. A user interface may include one or more graphical locator and/or cursor facilities allowing a user to interact with graphical models and/or combinations thereof, for instance using a touchscreen, touchpad, mouse, keyboard, and/or other manual data entry device. A “graphical user interface,” as used herein, is a user interface that allows users to interact with electronic devices through visual representations. In some embodiments, GUI 136 may include icons, menus, other visual indicators, or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in graphical user interface. Persons skilled in the art, upon reviewing the entirety of this disclosure, will be aware of various ways in which a graphical user interface and/or elements thereof may be implemented and/or used as described in this disclosure.

With continued reference to FIG. 1, GUI 136 may contain one or more interactive elements. An “interactive element” for the purposes of this disclosure is an element within a graphical user interface that allows for communication with apparatus by a user. For example, and without limitation, interactive elements may include push buttons wherein selection of a push button, such as for example, by using a mouse, may indicate to system to perform a particular function and display the result through graphical user interface. In one or more embodiments, interactive element may include push buttons on GUI, wherein the selection of a particular push button may result in a particular function. In one or more embodiments, interactive elements may include words, phrases, illustrations and the like to indicate the particular process the user would like system to perform. In one or more embodiments, interaction with interactive elements may result in the generation of incremental data entry 120 and/or portions thereof. In one or more embodiments, GUI 136 may be configured to visualize chatbot systems 188 (as described in further detail below), incremental data entries 120 and/or other information within user interface data structure 144.

With continued reference to FIG. 1, system 100 may further include a display device communicatively connected to at least a processor 108. A “display device” for the purposes of this disclosure is a device configured to show visual information. In some cases, display device may include a liquid crystal display (LCD), a cathode ray tube (CRT), a plasma display, a light emitting diode (LED) display, and any combinations thereof. Display device may include, but is not limited to, a smartphone, tablet, laptop, monitor, tablet, and the like. Display device may include a separate device that includes a transparent screen configured to display computer generated images and/or information. In some cases, display device may be configured to visually present one or more data through GUI 136 to a user, wherein a user may interact with the data through GUI 136. In some cases, a user may view GUI 136 through display device and/or remote device.

With continued reference to FIG. 1, processor 108 may be configured to receive incremental data entries 120 from one or more users interacting with GUI 136. In one or more embodiments, users may interact with GUI 136 in order to transmit information such as images, contextual datum 128 and/or the like. In one or more embodiments, GUI 136 may be displayed on remote device, wherein users may interact with system through interaction with GUI 136 on remote device.

With continued reference to FIG. 1, processor 108 is configured to generate GUI 136 containing an incremental input element 138. An “incremental input element” for the purposes of this disclosure refers to a particular configuration of a graphical user interface (GUI) that allows for the receipt of incremental data entries. For example, and without limitation, incremental input element 138 may include text boxes that describe the type of information being requested, input fields that allow for the input of information and/or the like. For the purposes of this disclosure, an “incremental input element,” is a portion of a graphical user interface which allows for a user to input incremental data. In one or more embodiments, incremental input element 138 may include and/or be included in a graphical view. In one or more embodiments, incremental input element 138 may include selectable event graphics, selectable event handlers, interactive elements, display elements and/or the like. In one or more embodiments, GUI 136 may contain incremental input element 138 wherein a user may interact with one or more portions of incremental input element 138 in order to input incremental data entries 120. In one or more embodiments, incremental input element 138 may include input fields that allow for the receipt of contextual datum 128. In one or more embodiments, incremental input element 138 may include selectable event graphics that allow for selection in order to input image 124. In one or more embodiments, selectable event graphics may include display element, such as images depicting documents and/to data files in order to signify to a user that the selectable event graphic corresponds to the receipt of data files, such as images. In one or more embodiments, incremental input element 138 may include information describing the type of information required in order to receive incremental data entry. In one or more embodiments, incremental input element 138 may include interactive elements, such as ‘submit’ buttons that allows for a user to submit incremental data entries upon complete input of incremental data entry 120. In one or more embodiments, incremental input element 138 may contain interactive elements, that allow for a user to submit multiple incremental data entries, wherein a user may first be prompted to input a first incremental data entry, then upon competition, be prompted to input a second incremental data entry. In one or more embodiments, computing device may command GUI 136 to include incremental input element 138 such that a user may input information through GUI 136. In one or more embodiments, incremental input element 138 may allow for a user to interact with GUI in order to input incremental data entry 120. In one or more embodiments, incremental input element 138 may include a particular configuration of GUI 136, wherein said particular configuration is structured for the receipt of incremental data entries. In one or more embodiments, processor 108 may be configured to generate a GUI 136 containing incremental input element 138. In one or more embodiments, incremental data entries 120 may be received through incremental input element 138 of GUI 136. In one or more embodiments, incremental input element 138 may include text boxes, selectable event handlers, selectable event graphics and/or the like that allow for the receipt of incremental data entries 120. In one or more embodiments, incremental input 138 element may contain a selectable event handler, wherein selection of the selectable event handler may signify to processor 108 to modify GUI and process incremental data entries 120. In one or more embodiments, selectable event handler may correspond to a selectable event graphic such as a ‘submit’ button, wherein selection of the submit button may signify to processor to generate journal entries and modify GUI to display the journal entries.

With continued reference to FIG. 1, processor 108 may be configured to identify a quality of incremental data entries 120 prior to processing. In one or more embodiments, identifying a quality of incremental data entries 120 may include identifying whether key information is present within incremental data entries 120, such as but not limited to, a name, a date, an image, a numerical view and/or the like. In one or more embodiments, processor 108 may be configured to compare incremental data entries 120 to one or more data standard thresholds 140. A “data standard threshold” for the purposes of this disclosure is a parameter that indicates whether a piece of information is suitable for processing. For example, and without limitation, data standard threshold 140 may include a parameter indicating that at least a price must be present within incremental data entry 120. In one or more embodiments, data standard threshold 140 may include rules and/or parameters that require adherence prior to processing of incremental data entry 120. In one or more embodiments, data standard thresholds 140 may include rules and/or parameters such as minimum file size of an image, requirements for a name, requirements for a date, requirements indicating whether the incremental data entry 120 refers to a credit or debit and/or the like. In one or more embodiments, data standard threshold 140 may include the presence of an image, wherein an incremental data entry 120 lacking an image 124 may not meet one or more data standard thresholds 140. In one or more embodiments, data standard thresholds 140 may include rules and/or parameters indicating that an image 124 be legible. For example, without limitation data standard thresholds 140 may indicate that an image 124 should be capable of text recognition, wherein images containing low quality and cannot be properly deciphered may not meet one or more data standard thresholds 140. In one or more embodiments, data standard thresholds 140 may include rules and/or parameters indicating that a particular piece of vital information be required prior to receipt of an incremental data entry 120. In one or more embodiments, processor 108 may be configured to iteratively compare incremental data entry 120 to one or more data standard thresholds 140 until the data standard thresholds 140 are met. In one or more embodiments, a user may iteratively input additional information associated with incremental data entry 120 until one or more data standard thresholds 140 are met.

With continued reference to FIG. 1, at least one data standard threshold 140 may include whether information within image 124 is legible such that it may be converted into machine-readable text. In one or more embodiments, processor 108 may perform one or more OCR processes in order to extract textual information from within image. In one or more embodiments, failure to extract textual information may indicate that the image 124 quality is not suitable. In one or more embodiments, failure to extract textual information may indicate that the image 124 fails on or more data standard thresholds 140.

Still referring to FIG. 1, in some embodiments, optical character recognition or optical character reader (OCR) includes automatic conversion of images of written (e.g., typed, handwritten or printed text) into machine-encoded text. In some cases, recognition of at least a keyword from an image 124 component may include one or more processes, including without limitation optical character recognition (OCR), optical word recognition, intelligent character recognition, intelligent word recognition, and the like. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine learning processes. In some cases, intelligent word recognition (IWR) may recognize written text, one word at a time, for instance by employing machine learning processes.

Still referring to FIG. 1, in some cases OCR may be an “offline” process, which analyses a static document or image 124 frame. In some cases, handwriting movement analysis can be used as input to handwriting recognition. For example, instead of merely using shapes of glyphs and words, this technique may capture motions, such as the order in which segments are drawn, the direction, and the pattern of putting the pen down and lifting it. This additional information can make handwriting recognition more accurate. In some cases, this technology may be referred to as “online” character recognition, dynamic character recognition, real-time character recognition, and intelligent character recognition.

Still referring to FIG. 1, in some cases, OCR processes may employ pre-processing of image 124 component. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform (e.g., homography or affine transform) to image 124 component to align text. In some cases, a de-speckle process may include removing positive and negative spots and/or smoothing edges. In some cases, a binarization process may include converting an image 124 from color or greyscale to black-and-white (i.e., a binary image). Binarization may be performed as a simple way of separating text (or any other desired image 124 component) from a background of image 124 component. In some cases, binarization may be required for example if an employed OCR algorithm only works on binary images. In some cases. A line removal process may include removal of non-glyph or non-character imagery (e.g., boxes and lines). In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify script allowing an appropriate OCR algorithm to be selected. In some cases, a character isolation or “segmentation” process may separate signal characters, for example character-based OCR algorithms. In some cases, a normalization process may normalize aspect ratio and/or scale of image 124 component.

Still referring to FIG. 1, in some embodiments an OCR process will include an OCR algorithm. Exemplary OCR algorithms include matrix matching process and/or feature extraction processes. Matrix matching may involve comparing an image 124 to a stored glyph on a pixel-by-pixel basis. In some case, matrix matching may also be known as “pattern matching,” “pattern recognition,” and/or “image 124 correlation.” Matrix matching may rely on an input glyph being correctly isolated from the rest of the image 124 component. Matrix matching may also rely on a stored glyph being in a similar font and at a same scale as input glyph. Matrix matching may work best with typewritten text.

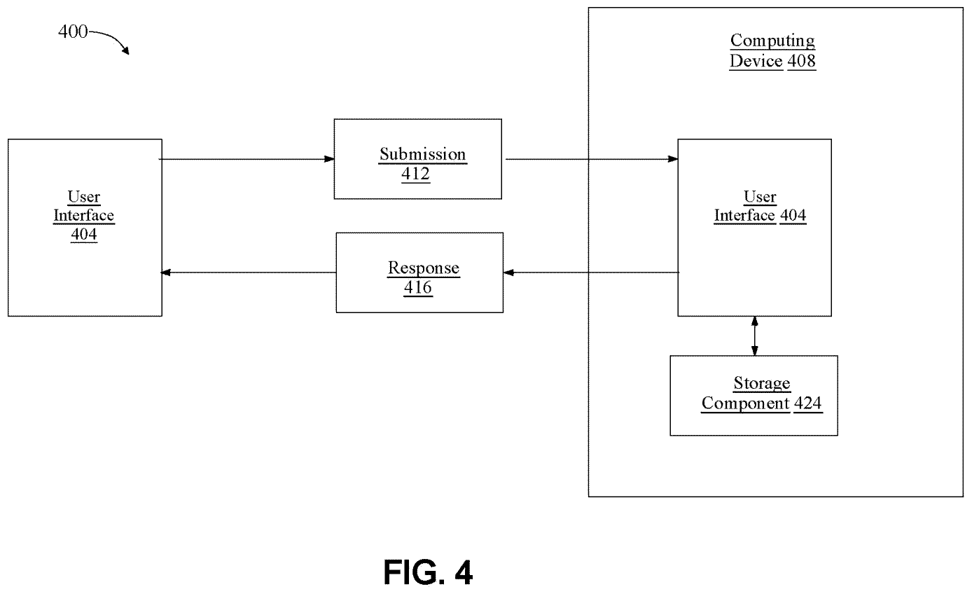

Still referring to FIG. 1, in some embodiments, an OCR process may include a feature extraction process. In some cases, feature extraction may decompose a glyph into features. Exemplary non-limiting features may include corners, edges, lines, closed loops, line direction, line intersections, and the like. In some cases, feature extraction may reduce dimensionality of representation and may make the recognition process computationally more efficient. In some cases, extracted feature can be compared with an abstract vector-like representation of a character, which might reduce to one or more glyph prototypes. General techniques of feature detection in computer vision are applicable to this type of OCR. In some embodiments, machine-learning process like nearest neighbor classifiers (e.g., k-nearest neighbors algorithm) can be used to compare image 124 features with stored glyph features and choose a nearest match. OCR may employ any machine-learning process described in this disclosure, for example machine-learning processes described with reference to FIGS. 4-7. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

Still referring to FIG. 1, in some cases, OCR may employ a two-pass approach to character recognition. Second pass may include adaptive recognition and use letter shapes recognized with high confidence on a first pass to recognize better remaining letters on the second pass. In some cases, two-pass approach may be advantageous for unusual fonts or low-quality image 124 components where visual verbal content may be distorted. Another exemplary OCR software tool include OCRopus. OCRopus development is led by German Research Centre for Artificial Intelligence in Kaiserslautern, Germany. In some cases, OCR software may employ neural networks, for example neural networks as taught in reference to FIGS. 4-7.

Still referring to FIG. 1, in some cases, OCR may include post-processing. For example, OCR accuracy can be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make us of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

With continued reference to FIG. 1, processor 108 may be configured to extract textual data from image 124 within incremental data entry 120 using an OCR processes as described above. “Textual data” for the purposes of this disclosure refers to information that is provided in text-based format. For example, and without limitation, textual data may include information provided in the form of alphanumeric characters. In one or more embodiments, textual data may include information that is contained in a machine-readable format. In one or more embodiments, processor 108 may compare textual data to one or more data standard thresholds 140 to determine if textual data was properly extracted from image. In one or more embodiments, data standard thresholds 140 may include the identification of illegible words or symbols that may indicate that an OCR process was unsuccessful. For example, and without limitation, a word “he110” may be illegible as the OCR process was unable to properly extract the word “hello”. In one or more embodiments, data standard thresholds 140 may include rules and/or determinations about whether a particular word or phrase was extracted due to image 124 quality. In one or more embodiments, processor 108 may be configured to iteratively identify textual information within image, wherein failure to properly extract textual information may indicate failure of one or more data standard thresholds 140.

With continued reference to FIG. 1, in one or more embodiments, processor 108 may iteratively modify the graphical user interface as a function of the one or more data standard thresholds 140 by displaying at least a datum representative of at least one failure of at least one data standard threshold 140. In one or more embodiments, processor 108 may modify GUI 136 to display to user a particular data standard threshold 140 that had not been met. In one or more embodiments, processor 108 may display a notification through GUI 136 indicating to user that a particular incremental data entry 120 failed to meet one or more data standard thresholds 140. In one or more embodiments, processor 108 may display a datum representative of the failure by displaying information indicating the one or more data standard thresholds 140 that have not yet been met. In one or more embodiments, a datum representative of at least one failure may include a prompt to the user to include supplemental information to the incremental data entry 120, such as but not limited to, a name, a date, a re-uploaded image 124 that contains machine readable information and/or the like. In one or more embodiments, processor 108 may display a datum representative of at least one failure by indicating to a user to input and/or modify a particular piece of information in order to incremental data entry 120 to meet one or more data standard thresholds 140. In one or more embodiments, processor 108 may be configured to iteratively modify GUI, until one or more data standard thresholds 140 are met. IN one or more embodiments, processor 108 may present notifications in the form of pop-up windows, text boxes and/or the like in order to inform a user there was at least one failure of at least one data standard threshold 140.

With continued reference to FIG. 1, processor 108 may be configured to iteratively receive modified data entries from the one or more users through the graphical user interface until an adherence of the one or more data standard thresholds 140 is satisfied. A “modified data entry” for the purposes of this disclosure refers to an incremental data entry 120 that has been modified in order to meet one or more data standard thresholds 140. For example, and without limitation, modified data entry may include the addition of a name, the addition of a date, the addition of an image, the replacement of a non-conforming image 124 and/or the like. In one or more embodiments, processor 108 may be configured to receive modified data entries and compare modified data entries to one or more data standard thresholds 140. In one or more embodiments, processor 108 may be configured to iteratively receive modified data entries until one or more data standard thresholds 140 are satisfied. For example, and without limitation, processor 108 may be configured to iteratively inform a user that a date is missing, until a date is finally received.

With continued reference to FIG. 1, upon receipt of incremental data entry 120, processor 108 may be configured to store incremental data entry 120 on database. In one or more embodiments, incremental data entry 120 may be stored for future reference and/or in order to provide proof in the future for information extracted from incremental data entries 120.

With continued reference to FIG. 1, processor 108 is configured to generate a unique identifier 148 for each incremental data entry 120. A “unique identifier” for the purposes of this disclosure refers a specific piece of information assigned to an object that distinctly differentiates the object from others within a system. For example, without limitation, unique identifier 148 may set of alphanumeric characters that is assigned to an incremental data entry 120 and used to differentiate the incremental data entry 120 from others in the system. In one or more embodiments, unique identifier 148 may be used to identify a particular incremental data entry 120 from a plurality of incremental data entries 120 located on database. In one or more embodiments, incremental data entries 120 may be similar and thus require a unique identifier 148 in order to differentiate between two data sets. In one or more embodiments, unique identifier 148 may include a QR code, a series of numbers, a series of characters, a series of alphanumeric characters and/or the like. In one or more embodiments, all information associated with a particular incremental data entry 120 may be retrieved using unique identifier 148. For example, and without limitation, unique identifier 148 may be used to retrieve comments or modifications made with respect to a particular unique identifier 148. In one or more embodiments, unique identifier 148 may be used to located textual datum extracted from images, may be used to retrieve images associated with incremental data entry 120, used to retrieve contextual datum 128 and/or used to retrieve any information that may be associated with incremental data entry 120. In one or more embodiments, unique identifier 148 may allow for identification of incremental data entry 120 on database. In one or more embodiments, unique identifier 148 may include a vector as described in further detail below. In one or more embodiments, incremental data entries 120 may be referred to and/or located based on their vectors. In one or more embodiments unique identifiers 148 may be used as confirmation that an incremental data entry 120 was received. In one or more embodiments, processor 108 may update a list of a plurality of unique identifiers 148 (referred to herein as an “entry list”) upon receipt of an incremental data entry 120. In one or more embodiments, the entry list may serve as a reference for all incremental data entries 120 received and their status. In one or more embodiments, processor 108 may notify a user that an entry list has been updated upon receipt of incremental data entry 120. In one or more embodiments the entry list may be used as verification that all incremental data entries 120 have been accounted for. In one or more embodiments, upon processing of information, processor 108 may use entry list as verification that all incremental data entries 120 have been received. In one or more embodiments, both unique identifiers 148 and entry list may be used to ensure that incremental data entries 120 are not missed and/or have not been accounted for more than once.

With continued reference to FIG. 1, in one or more embodiments, processor 108 is configured to generate a document representation 152 of incremental data entry 120. A “Document representation” for the purposes of this disclosure refers to a single-dimensional data structure is representative of a piece of information. For example, and without limitation document representation 152 may include a single dimensional data structure that is representation of information contained within incremental data entry 120. In another non limiting example, document representation 152 may include a data file that contains texts and/or characters that were extracted from an image 124 within incremental data entry 120 following an OCR process. In one or more embodiments, document representation 152 may include a single dimensional data structure wherein information within document representation 152 may be contained in a text-based and/or alphanumeric format. In one or more embodiments, document representation 152 may include any textual information that has been extracted from incremental data entry 120. This may include but is not limited to, textual information received from contextual datum 128, information received from an OCR process as described above and/or the like. In one or more embodiments, document representation 152 may include a reduced dimensionality in comparison to incremental data entry 120 in order to increase computational efficiency. For example, and without limitation incremental data entry 120 may include data, such as images, in a two dimensional format, whereas document representation 152 may include information in a one dimensional format. In one or more embodiments, processor 108 may generate document representation 152 by extracting any characters, alphanumeric characters and/or the like from incremental data entries 120. In one or more embodiments, document representation 152 may include a representation of an image 124 within incremental data entry 120 wherein document representation 152 may represent information in a lower dimensionality. In one or more embodiments, document representation 152 may include information that has been converted in order to reduce dimensionality and increased computational efficiency during processing. In one or more embodiments, document representation 152 may ensure that all information within incremental data entry 120 are preserved within the same format and/or dimensional structure. In one or more embodiments, document representation 152 may ensure that information fed into a machine learning model and/or large language model is all contained within the same format. In one or more embodiments, document representation 152 may ensure that a machine learning model requires less training data to output results because the machine learning model only needs to be trained on one specific dimensional data structure.

With continued reference to FIG. 1, in one or more embodiments, document representation 152 may include a vector. A “vector” as defined in this disclosure is a data structure that represents information that is contained a high dimensional space. For example, and without limitation, vector may include a numerical and/or alpha numerical representation of image 124 within incremental data entry 120. Such vector and/or embedding may include and/or represent an element of a vector space; a vector may alternatively or additionally be represented as an element of a vector space, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. A vector may be represented as an n-tuple of values, where n is one or more values, as described in further detail below; a vector may alternatively or additionally be represented as an element of a vector space, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent, for instance as measured using cosine similarity as computed using a dot product of two vectors; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute 1 as derived using a Pythagorean norm:

$$l = \sqrt{{\sum }_{i = 0}^{n} {a}_{i}^{2}} ,$$

where ai is attribute number i of the vector. Scaling and/or normalization may function to make vector comparison independent of absolute quantities of attributes, while preserving any dependency on similarity of attributes. A two-dimensional subspace of a vector space may be defined by any two orthogonal vectors contained within the vector space. Two-dimensional subspace of a vector space may be defined by any two orthogonal and/or linearly independent vectors contained within the vector space; similarly, an n-dimensional space may be defined by n vectors that are linearly independent and/or orthogonal contained within a vector space. A vector's “norm” is a scalar value, denoted ∥a∥ indicating the vector's length or size, and may be defined, as a non-limiting example, according to a Euclidean norm for an n-dimensional vector a as:

$$‖ a ‖ = \sqrt{{\sum }_{i = 0}^{n} {a}_{i}^{2}}$$

Any vectors as described herein may be scaled, such that each vector represents each attribute along an equivalent scale of values. In an embodiment associating [data in your case] to one another as described above may include computing a degree of vector similarity between a vector representing each [data element] and a vector representing another [data element]; vector similarity may be measured according to any norm for proximity and/or similarity of two vectors, including without limitation cosine similarity. As used in this disclosure “cosine similarity” is a measure of similarity between two-non-zero vectors of a vector space, wherein determining the similarity includes determining the cosine of the angle between the two vectors. Cosine similarity may be computed as a function of using a dot product of the two vectors divided by the lengths of the two vectors, or the dot product of two normalized vectors. For instance, and without limitation, a cosine of 0° is 1, wherein it is less than 1 for any angle in the interval (0,π) radians. Cosine similarity may be a judgment of orientation and not magnitude, wherein two vectors with the same orientation have a cosine similarity of 1, two vectors oriented at 90° relative to each other have a similarity of 0, and two vectors diametrically opposed have a similarity of −1, independent of their magnitude. As a non-limiting example, vectors may be considered similar if parallel to one another. As a further non-limiting example, vectors may be considered dissimilar if orthogonal to one another. As a further non-limiting example, vectors may be considered uncorrelated if opposite to one another. Additionally, or alternatively, degree of similarity may include any other geometric measure of distance between vectors.

With continued reference to FIG. 1, vectors may include single dimensional data structures that represent information that is contained in a higher dimensional space. In one or more embodiments, vectors may increase computational efficiency by reducing a dimensionality of information within incremental data entry 120. In one or more embodiments, vectors may be generated using a Convolutional neural network (CNN), a vision transformer (ViT) and/or any other machine learning model as described in this disclosure. In one or more embodiments, a machine learning model such as deep learning model may be trained to extract important features from an image, such as but not limited to, edges, textures, shapes, colors, textual information and/or the like. In one or more embodiments, the important features may be transformed into a fixed-length numerical representation such as a vector. In one or more embodiments, the vectors may exist in high-dimensional space wherein similar images have vectors that are positioned closer together. In one or more embodiments, vectors may allow for fasting computer processing wherein similarities may be identified using cosine similarity and/or Euclidean distance rather than comparison pixel by pixel. In one or more embodiments, vectors may be used to extract only relevant information from an image 124 and input only the relevant information into a machine learning model. In one or more embodiments, a deep learning model may be trained to only extract relevant information in order to generate vector, wherein only relevant information may be fed to the machine learning model and/or large language model. In one or more embodiments, processor 108 may first be configured to convert images to a textual format using an OCR process and convert the extracted text into a vector. In one or more embodiments, processor 108 may use models such as Word2Vec, BERT and/or any other encoders that allow for the conversion of text into a vector. In one or more embodiments, processor 108 may further be configured to combine both visual and textual embeddings and/or vectors into a unified vector that represents both textual information and the image.

With continued reference to FIG. 1, processor 108 may use a machine learning model such as any machine learning model as described in this disclosure to generate document representation 152 and/or vectors. In one or more embodiments, processor 108 may use a machine learning module to implement one or more algorithms or generate one or more machine learning models, such as a representation machine learning model 156. However, the machine learning module is exemplary and may not be necessary to generate one or more machine learning models and perform any machine learning described herein. In one or more embodiments, one or more machine-learning models may be generated using training data. Training data may include inputs and corresponding predetermined outputs so that a machine-learning model may use correlations between the provided exemplary inputs and outputs to develop an algorithm and/or relationship that then allows machine-learning model to determine its own outputs for inputs. Training data may contain correlations that a machine-learning process may use to model relationships between two or more categories of data elements. Exemplary inputs and outputs may come from a database, such as any database 116 described in this disclosure, or be provided by a user. In other embodiments, a machine-learning module may obtain a training set by querying a communicatively connected database 116 that includes past inputs and outputs. Training data may include inputs from various types of databases, resources, and/or user inputs and outputs correlated to each of those inputs so that a machine-learning model may determine an output. Correlations may indicate causative and/or predictive links between data, which may be modeled as relationships, such as mathematical relationships, by machine-learning models, as described in further detail below. In one or more embodiments, training data may be formatted and/or organized by categories of data elements by, for example, associating data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements. In a further embodiment, training data may include previous outputs such that one or more machine learning models iteratively produces outputs.

With continued reference to FIG. 1, a machine learning model such as representation machine learning model 156 may include parameter values. “Parameter values” for the purposes of this disclosure are internal variables that a machine learning model has generated from training data in order to make predictions. In one or more embodiments, parameter values may be adjusted during pretraining or training in order to minimize a loss function. In one or more embodiments, during training, predicted outputs of the machine learning model are compared to actual outputs wherein the discrepancy between predicted output and actual outputs are measured in order to minimize a loss function. A loss function also known an “error function” may measure the difference between predicted outputs and actual outputs in order to improve the performance of the machine learning model. A loss function may quantify the error margin between a predicted output and an actual output wherein the error margin may be sought to be minimized during the training process. The loss function may allow for minimization of discrepancies between predicted outputs and actual outputs of the machine learning model. In one or more embodiments, the loss function may adjust parameter values of the machine learning model. In one or more embodiments, in a linear regression model, parameter values may include coefficients assigned to each feature and the bias term. In one or more embodiments, in a neural network, parameter values may include weights and biases associated with the connection between neurons or nodes within layers of the network. In one or more embodiments, during pretraining and/or training of the machine learning model, parameter values of the machine learning model (e.g. representation machine learning model 156) may be adjusted as a based on feedback elements provided by a user, 3^{rd} party, large language model and/or the like. In one or more embodiments, feedback elements may include feedback that a particular document representation 152 does not correctly portray the content of an image. In one or more embodiments, parameter values may be iteratively adjusted in order to refine the machine learning model and ensure that document representation 152 properly reflect the information within an image.

With continued reference to FIG. 1, document representation 152 may be generated using a machine learning model such as representation machine learning model 156. In one or more embodiments, representation machine learning model 156 may include any machine learning model as described in this disclosure. In one or more embodiments, representation machine learning model 156 may be configured to receive an image, such as an image 124 within incremental data entry 120 and generate document representation 152 as an output. In one or more embodiments, representation machine learning model 156 may be trained with representation training data 160 correlating a plurality of images to a plurality of document representations 152. In one or more embodiments, representation training data 160 includes a plurality of images. In one or more embodiments, representation training data 160 may be received by a user, 3^{rd} party and/or the like. In one or more embodiments, representation training data 160 may be generated as a function of training a machine learning model. In one or more embodiments, training representation machine learning model 156 may include receiving a plurality of images. In one or more embodiments, the plurality of images, may include images of financial documents, images of receipts, images of invoices and/or the like. In one or more embodiments, plurality of images may be received by a WebCrawler configured to extract images associated with financial information. In one or more embodiments, plurality of images may further includes images received from previous incremental data entries 120. In one or more embodiments, plurality of images may be labeled with bounding boxes, segmentation masks, text annotations and/or the like in order to indicate to representation machine learning model 156 the particular region of interest. In one or more embodiments, regions of interest may include portions of on image 124 that contain relevant financial information, such as text within the boundary of a receipt. In one or more embodiments, representation machine learning model 156 may be initialized using random parameter values. In one or more embodiments, representation machine learning model 156 may be initialized using parameter values fed from a large language model in order to increase the training process. In one or more embodiments, parameter values received from a large language model may contain some degree of accuracy and thereby increase the training process and resultingly lead to increased computational efficiency. In one or more embodiments, plurality of images may be annotated in order to train representation machine learning model 156 to generate document representation 152 based on regions of interest indicated by the annotation. In one or more embodiments, representation machine learning model 156 may be trained to give more weight to regions of interest and to minimize loss functions based on the regions of interest. In one or more embodiments, representation machine learning model 156 may be trained using contrastive learning wherein similar images may contain vectors that are positioned closer together while non-similar images may be placed further apart. In one or more embodiments, plurality of images may be labeled based on their similarities wherein representation machine learning model 156 may be trained to update parameter values to ensure that similar images contain similar vectors. In one or more embodiments, representation machine learning model 156 may be trained to extract feature vectors only from regions of interest and to ensure that images with similar highlighted regions have similar vectors. In one or more embodiments, representation machine learning model 156 may be trained to extract only relevant information that may be used in connection with incremental data entry 120. This may include textual information such as costs, revenue, the name of the person that owes money or is owed money, and/or the like. In one or more embodiments, representation machine learning model 156 may be configured to ensure that images with similar regions of interest contain vectors that are mapped closed together. In one or more embodiments, representation machine learning model 156 may receive a plurality of images and generate a plurality of document representations 152 (or predictions of document representations 152). In one or more embodiments, representation machine learning model 156 may then compare document representations 152 of similar images in order to calculate a difference (loss) between the models predictions, wherein for example, document representation 152 of similar images that are situated further apparat may indicate a larger difference. In one or more embodiments, representation machine learning model 156 May adjust weights and/or parameter values of the machine learning model in order to predict document representations 152 that are closer together. In one or more embodiments, representation machine learning model 156 may minimize a loss between plurality of document representations 152 by adjusting parameter values of representation machine learning model 156. For the purposes of this disclosure, in a loss function, a “loss” refers to a numerical value that represents the difference between a model's predicted output and the actual target value. In one or more embodiments, representation machine learning model 156 may update one or more parameter values of the machine learning model as a function of the loss and/or in order to minimize the loss function. In one or more embodiments, predicted outputs of representation machine learning model 156 may include generated document representation 152, wherein actual outputs may include similarities between similar images and/or a determination of whether a particular region of interest was properly captured in a vector. In one or more embodiments, representation machine learning model 156 may be configured to minimize a loss function in order to ensure that only relevant features are contained within the document representation 152.

With continued reference to FIG. 1, processor 108 is configured to generate a journal entry 164 for each incremental data entry 120 the one or more incremental data entries 120. In one or more embodiments, processor 108 may generate a journal entry 164 using incremental data entries 120 and/or using document representations 152. In one or more embodiments, one or more processes as described in this disclosure that is used to generate journal entries 164 from incremental data entries 120 may similarly be used to generate journal entries 164 using document representations 152. A “journal entry” for the purposes of this disclosure refers to a recordation of the incremental data entry 120. In one or more embodiments, journal entry 164 includes a recordation of incremental data entry 120 and/or portions thereof in a matrix format. As used in this disclosure “matrix” is a rectangular array or table of numbers, symbols, expressions, vectors, and/or representations arranged in rows and columns. For instance, and without limitation, matrix may include rows and/or columns comprised of vectors representing information extracted from incremental data entries 120 where each row and/or column is a vector representing a distinct data element or matrix value 168. In one or more embodiments, journal entry 164 may include a matrix wherein values within matrix may include information extracted from incremental data entry 120. In one or more embodiments, journal entry 164 may indicate a date of purchase, a particular amount of credit, a particular amount of debit, and/or the like. In one or more embodiments, journal entry 164 may include a matrix, wherein the matrix is populated with matrix values 168. “Matrix values” as used herein refer to the data elements within a matrix. For example, and without limitation, matrix value 168 may include “300” wherein the 300 may indicate a that a debit of 300$ is owed. In one or more embodiments, journal entry 164 may include a plurality of matrix values 168 that contain relevant information from incremental data such as but not limited to a date, the type of financial transaction involved, the amount involved in the financial transaction, the parties to the financial transaction and/or the like. In one or more embodiments, each row or column within the matrix may contain a different matrix value 168 that corresponds to a differing element extracted from incremental data entry 120. For example and without limitation, a first column may be associated with a date, a second column associated with money owed, a third column associated with money received and/or the like. In one or more embodiments, rows and/or columns within the matrix may be populated based on the information contained within incremental data entry 120. For example, without limitation, a row may be populated if information within incremental data entry 120 includes relevant information needed to populate a particular row or column. In one or more embodiment journal entry 164 may include extracted information from incremental data entry 120 that is presented in a structured format such as in row, columns and/or cells. In one or more embodiments, journal entry 164 may include a particular account number in which an incremental data entry 120 belongs to, an account name associated with the incremental data entry 120, a description of the incremental data entry 120, a specific numerical values associated with the numerical data entry and/or whether the incremental data entry 120 relates to a credit or debit. In one or more embodiments, journal entry 164 may refer to a single record of a financial transaction in an accounting system. In one or more embodiments, journal entry 164 may include the date of the transaction, the accounts involved, the amounts to be debited and credited, a brief description of the transaction, and/or the unique identifier 148.

With continued reference to FIG. 1, journal entry 164 may include matrix identifiers 172 for each matrix value 168. A “Matrix identifier” for the purposes of this disclosure refers to a location of a matrix value 168 within a matrix. For example and without limitation, matrix identifier 172 may indicate that a matrix value 168 belongs to a second row and third column within the matrix. In one or more embodiments, matrix identifiers 172 may be used to identify a location of matrix values 168 within a matrix. In one or more embodiments, each cells, row and/or column within matrix may correspond to a particular information associated with a transaction wherein matrix identifier 172 may include information indicating what location the matrix value 168 should be located in. In another non limiting example, a matrix value 168 may include ‘300$’ wherein the matrix identifier 172 may indicate if the matrix value 168 belongs in the column associated with credits or the column associated with debits. In one or more embodiments journal entry 164 may include matrix identifiers 172 and associated matrix values 168. In one or more embodiments, generating journal entry 164 may include receiving a matrix with a plurality of matrix identifiers 172 and assigning a matrix value 168 to one or more matrix identifiers 172. In one or more embodiments, processor 108 may generate journal entry 164 by receiving a template containing a matrix with matrix identifiers 172 and assigning a matrix value 168 to each matrix identifier 172. In one or more embodiments, processor 108 may extract information from incremental data entries 120 in the form of matrix values 168 and assign said matrix values 168 to matrix identifiers 172 in order to position each matrix value 168 within a matrix. In one or more embodiments, each journal entry 164 includes one or more matrix identifiers 172 and one or more associated matrix values 168. This is described in further detail below.

With continued reference to FIG. 1, processor 108 may use a large language model to generate journal entries 164. In one or more embodiments, incremental data entries 120, document representations 152 and/or contextual datum 128 may be transmitted to large language model, wherein large language model may output journal entries 164.

Still referring to FIG. 1, system 100 may include and/or be communicative connected to a large language model (LLM 176). A “large language model,” as used herein, is a deep learning data structure that can recognize, summarize, translate, predict and/or generate text and other content based on knowledge gained from massive datasets. Large language models may be trained on large sets of data. Training sets may be drawn from diverse sets of data such as, as non-limiting examples, novels, blog posts, articles, emails, unstructured data, electronic records, and the like. In some embodiments, training sets may include a variety of subject matters, such as, nonlimiting examples, medical report documents, electronic health records, entity documents, business documents, financial documents, invoices, receipts, inventory documentation, emails, user communications, advertising documents, newspaper articles, and the like. In some embodiments, training sets of an LLM 176 may include information from one or more public or private databases. As a non-limiting example, training sets may include databases associated with an entity. In some embodiments, training sets may include portions of documents associated with the electronic records correlated to examples of outputs. In an embodiment, an LLM 176 may include one or more architectures based on capability requirements of an LLM 176. Exemplary architectures may include, without limitation, GPT (Generative Pretrained Transformer), BERT (Bidirectional Encoder Representations from Transformers), T5 (Text-To-Text Transfer Transformer), and the like. Architecture choice may depend on the capability needed such as generative, contextual, or other specific capabilities.

With continued reference to FIG. 1, in some embodiments, an LLM may be generally trained. As used in this disclosure, a “generally trained” LLM is an LLM that is trained on a general training set comprising a variety of subject matters, data sets, and fields. In some embodiments, an LLM may be initially generally trained. Additionally, or alternatively, an LLM may be specifically trained. As used in this disclosure, a “specifically trained” LLM is an LLM that is trained on a specific training set, wherein the specific training set includes data including specific correlations for the LLM to learn. As a non-limiting example, an LLM may be generally trained on a general training set, then specifically trained on a specific training set. In an embodiment, specific training of an LLM may be performed using a supervised machine learning process. In some embodiments, generally training an LLM may be performed using an unsupervised machine learning process. As a non-limiting example, specific training set may include information from a database. As a non-limiting example, specific training set may include text related to the users such as user specific data for electronic records correlated to examples of outputs. In an embodiment, training one or more machine learning models may include setting the parameters of the one or more models (weights and biases) either randomly or using a pretrained model. Generally training one or more machine learning models on a large corpus of text data can provide a starting point for fine-tuning on a specific task. A model such as an LLM may learn by adjusting its parameters during the training process to minimize a defined loss function, which measures the difference between predicted outputs and ground truth. Once a model has been generally trained, the model may then be specifically trained to fine-tune the pretrained model on task-specific data to adapt it to the target task. Fine-tuning may involve training a model with task-specific training data, adjusting the model's weights to optimize performance for the particular task. In some cases, this may include optimizing the model's performance by fine-tuning hyperparameters such as learning rate, batch size, and regularization. Hyperparameter tuning may help in achieving the best performance and convergence during training. In an embodiment, fine-tuning a pretrained model such as an LLM may include fine-tuning the pretrained model using Low-Rank Adaptation (LoRA). As used in this disclosure, “Low-Rank Adaptation” is a training technique for large language models that modifies a subset of parameters in the model. Low-Rank Adaptation may be configured to make the training process more computationally efficient by avoiding a need to train an entire model from scratch. In an exemplary embodiment, a subset of parameters that are updated may include parameters that are associated with a specific task or domain.

With continued reference to FIG. 1, in some embodiments an LLM 176 may include and/or be produced using Generative Pretrained Transformer (GPT), GPT-2, GPT-3, GPT-4, and the like. GPT, GPT-2, GPT-3, GPT-3.5, and GPT-4 are products of Open AI Inc., of San Francisco, CA. An LLM 176 may include a text prediction based algorithm configured to receive an article and apply a probability distribution to the words already typed in a sentence to work out the most likely word to come next in augmented articles. For example, if some words that have already been typed are “Nice to meet”, then it may be highly likely that the word “you” will come next. An LLM 176 may output such predictions by ranking words by likelihood or a prompt parameter. For the example given above, an LLM 176 may score “you” as the most likely, “your” as the next most likely, “his” or “her” next, and the like. An LLM 176 may include an encoder component and a decoder component.

Still referring to FIG. 1, an LLM 176 may include a transformer architecture. In some embodiments, encoder component of an LLM 176 may include transformer architecture. A “transformer architecture,” for the purposes of this disclosure is a neural network architecture that uses self-attention and positional encoding. Transformer architecture may be designed to process sequential input data, such as natural language, with applications towards tasks such as translation and text summarization. Transformer architecture may process the entire input all at once. “Positional encoding,” for the purposes of this disclosure, refers to a data processing technique that encodes the location or position of an entity in a sequence. In some embodiments, each position in the sequence may be assigned a unique representation. In some embodiments, positional encoding may include mapping each position in the sequence to a position vector. In some embodiments, trigonometric functions, such as sine and cosine, may be used to determine the values in the position vector. In some embodiments, position vectors for a plurality of positions in a sequence may be assembled into a position matrix, wherein each row of position matrix may represent a position in the sequence.

With continued reference to FIG. 1, an LLM 176 and/or transformer architecture may include an attention mechanism. An “attention mechanism,” as used herein, is a part of a neural architecture that enables a system to dynamically quantify the relevant features of the input data. In the case of natural language processing, input data may be a sequence of textual elements. It may be applied directly to the raw input or to its higher-level representation.

With continued reference to FIG. 1, attention mechanism may represent an improvement over a limitation of an encoder-decoder model. An encoder-decider model encodes an input sequence to one fixed length vector from which the output is decoded at each time step. This issue may be seen as a problem when decoding long sequences because it may make it difficult for the neural network to cope with long sentences, such as those that are longer than the sentences in the training corpus. Applying an attention mechanism, an LLM 176 may predict the next word by searching for a set of positions in a source sentence where the most relevant information is concentrated. An LLM 176 may then predict the next word based on context vectors associated with these source positions and all the previously generated target words, such as textual data of a dictionary correlated to a prompt in a training data set. A “context vector,” as used herein, are fixed-length vector representations useful for document retrieval and word sense disambiguation.

Still referring to FIG. 1, attention mechanism may include, without limitation, generalized attention self-attention, multi-head attention, additive attention, global attention, and the like. In generalized attention, when a sequence of words or an image is fed to an LLM 176, it may verify each element of the input sequence and compare it against the output sequence. Each iteration may involve the mechanism's encoder capturing the input sequence and comparing it with each element of the decoder's sequence. From the comparison scores, the mechanism may then select the words or parts of the image hat it needs to pay attention to. In self-attention, an LLM 176 may pick up particular parts at different positions in the input sequence and over time compute an initial composition of the output sequence. In multi-head attention, an LLM 176 may include a transformer model of an attention mechanism. Attention mechanisms, as described above, may provide context for any position in the input sequence. For example, if the input data is a natural language sentence, the transformer does not have to process one word at a time. In multi-head attention, computations by an LLM 176 may be repeated over several iterations, each computation may form parallel layers known as attention heads. Each separate head may independently pass the input sequence and corresponding output sequence element through a separate head. A final attention score may be produced by combining attention scores at each head so that every nuance of the input sequence is taken into consideration. In additive attention (Bahdanau attention mechanism), an LLM 176 may make use of attention alignment scores based on a number of factors. Alignment scores may be calculated at different points in a neural network, and/or at different stages represented by discrete neural networks. Source or input sequence words are correlated with target or output sequence words but not to an exact degree. This correlation may take into account all hidden states and the final alignment score is the summation of the matrix of alignment scores. In global attention (Luong mechanism), in situations where neural machine translations are required, an LLM 176 may either attend to all source words or predict the target sentence, thereby attending to a smaller subset of words.

With continued reference to FIG. 1, multi-headed attention in encoder may apply a specific attention mechanism called self-attention. Self-attention allows models such as an LLM 176 or components thereof to associate each word in the input, to other words. As a non-limiting example, an LLM 176 may learn to associate the word “you”, with “how” and “are”. It's also possible that an LLM 176 learns that words structured in this pattern are typically a question and to respond appropriately. In some embodiments, to achieve self-attention, input may be fed into three distinct fully connected neural network layers to create query, key, and value vectors. A query vector may include an entity's learned representation for comparison to determine attention score. A key vector may include an entity's learned representation for determining the entity's relevance and attention weight. A value vector may include data used to generate output representations. Query, key, and value vectors may be fed through a linear layer; then, the query and key vectors may be multiplied using dot product matrix multiplication in order to produce a score matrix. The score matrix may determine the amount of focus for a word should be put on other words (thus, each word may be a score that corresponds to other words in the time-step). The values in score matrix may be scaled down. As a non-limiting example, score matrix may be divided by the square root of the dimension of the query and key vectors. In some embodiments, the softmax of the scaled scores in score matrix may be taken. The output of this softmax function may be called the attention weights. Attention weights may be multiplied by your value vector to obtain an output vector. The output vector may then be fed through a final linear layer.

Still referencing FIG. 1, in order to use self-attention in a multi-headed attention computation, query, key, and value may be split into N vectors before applying self-attention. Each self-attention process may be called a “head.” Each head may produce an output vector and each output vector from each head may be concatenated into a single vector. This single vector may then be fed through the final linear layer discussed above. In theory, each head can learn something different from the input, therefore giving the encoder model more representation power.

With continued reference to FIG. 1, encoder of transformer may include a residual connection. Residual connection may include adding the output from multi-headed attention to the positional input embedding. In some embodiments, the output from residual connection may go through a layer normalization. In some embodiments, the normalized residual output may be projected through a pointwise feed-forward network for further processing. The pointwise feed-forward network may include a couple of linear layers with a ReLU activation in between. The output may then be added to the input of the pointwise feed-forward network and further normalized.

Continuing to refer to FIG. 1, transformer architecture may include a decoder. Decoder may a multi-headed attention layer, a pointwise feed-forward layer, one or more residual connections, and layer normalization (particularly after each sub-layer), as discussed in more detail above. In some embodiments, decoder may include two multi-headed attention layers. In some embodiments, decoder may be autoregressive. For the purposes of this disclosure, “autoregressive” means that the decoder takes in a list of previous outputs as inputs along with encoder outputs containing attention information from the input.

With further reference to FIG. 1, in some embodiments, input to decoder may go through an embedding layer and positional encoding layer in order to obtain positional embeddings. Decoder may include a first multi-headed attention layer, wherein the first multi-headed attention layer may receive positional embeddings.

With continued reference to FIG. 1, first multi-headed attention layer may be configured to not condition to future tokens. As a non-limiting example, when computing attention scores on the word “am,” decoder should not have access to the word “fine” in “I am fine,” because that word is a future word that was generated after. The word “am” should only have access to itself and the words before it. In some embodiments, this may be accomplished by implementing a look-ahead mask. Look ahead mask is a matrix of the same dimensions as the scaled attention score matrix that is filled with “0s” and negative infinities. For example, the top right triangle portion of look-ahead mask may be filled with negative infinities. Look-ahead mask may be added to scaled attention score matrix to obtain a masked score matrix. Masked score matrix may include scaled attention scores in the lower-left triangle of the matrix and negative infinities in the upper-right triangle of the matrix. Then, when the softmax of this matrix is taken, the negative infinities will be zeroed out; this leaves zero attention scores for “future tokens.”

Still referring to FIG. 1, second multi-headed attention layer may use encoder outputs as queries and keys and the outputs from the first multi-headed attention layer as values. This process matches the encoder's input to the decoder's input, allowing the decoder to decide which encoder input is relevant to put a focus on. The output from second multi-headed attention layer may be fed through a pointwise feedforward layer for further processing.

With continued reference to FIG. 1, the output of the pointwise feedforward layer may be fed through a final linear layer. This final linear layer may act as a classifier. This classifier may be as big as the number of classes that you have. For example, if you have 10,000 classes for 10,000 words, the output of that classifier will be of size 10,000. The output of this classifier may be fed into a softmax layer which may serve to produce probability scores between zero and one. The index may be taken of the highest probability score in order to determine a predicted word.

Still referring to FIG. 1, decoder may take this output and add it to the decoder inputs. Decoder may continue decoding until a token is predicted. Decoder may stop decoding once it predicts an end token.

Continuing to refer to FIG. 1, in some embodiment, decoder may be stacked N layers high, with each layer taking in inputs from the encoder and layers before it. Stacking layers may allow an LLM 176 to learn to extract and focus on different combinations of attention from its attention heads.

With continued reference to FIG. 1, an LLM 176 may receive an input. Input may include a string of one or more characters. Inputs may additionally include unstructured data. For example, input may include one or more words, a sentence, a paragraph, a thought, a query, and the like. A “query” for the purposes of the disclosure is a string of characters that poses a question. In some embodiments, input may be received from a user device. User device may be any computing device 104 that is used by a user. As non-limiting examples, user device may include desktops, laptops, smartphones, tablets, and the like. In some embodiments, input may include any set of data associated with incremental data entries 120.

With continued reference to FIG. 1, an LLM 176 may generate at least one annotation as an output. At least one annotation may be any annotation as described herein. In some embodiments, an LLM 176 may include multiple sets of transformer architecture as described above. Output may include a textual output. A “textual output,” for the purposes of this disclosure is an output comprising a string of one or more characters. Textual output may include, for example, a plurality of annotations for unstructured data. In some embodiments, textual output may include a phrase or sentence identifying the status of a user query. In some embodiments, textual output may include a sentence or plurality of sentences describing a response to a user query. As a non-limiting example, this may include journal entries 164, financial reports and/or the like.

With continued reference to FIG. 1, LLM 176 may be configured to receive incremental data entries 120 and/or document representations 152 and output journal entries 164. In one or more embodiments, LLM 176 may be configured to extract information from incremental data entries 120, such as for example, a date, an amount, whether the financial transaction involves a debit or a credit, and/or the like. In one or more embodiments, LLM 176 may be configured to use extracted information from incremental data entry 120 for use in journal entry 164. In one or more embodiments, LLM 176 may be given instructions to populate a template of a matrix containing matrix identifiers 172 and empty matrix values 168. In one or more embodiments, LLM 176 may be configured to populate matrix with matrix values 168 if any. In one or more embodiments, LLM 176 may be configured to identify an associated matrix value 168 for each matrix identifier 172. In one or more embodiments, each matrix identifier 172 may be classified to a particular categorization, for example, and without limitation, matrix identifiers 172 may be classified to dates, descriptions of transactions, account numbers, credits, debits and/or the like, wherein LLM 176 may be configured to identify elements within incremental data entries 120 that would be classified to the same categorization. For example, and without limitation, LLM 176 may be configured to identify and/or extract a date to be assigned to a matrix identifier 172 associated with a date classification. In one or more embodiments, LLM 176 may be configured to identify and/or generate matrix values 168 for each matrix identifier 172. In one or more embodiments, LLM 176 may be configured to identify and/or generate matrix values 168 for each matrix field and/or cell. In one or more embodiments, LLM 176 may utilize contextual datum 128 to distinguish and/or to properly classify data elements within incremental data entry 120. For example, and without limitation, contextual datum 128 may indicate that an image 124 is for a debit owed, wherein LLM 176 may understand that any costs or values identified may be associated with a debit rather than a credit. In one or more embodiments, contextual datum 128 may provide information that may otherwise not be ascertained from image 124 alone. For example, and without limitation, contextual datum 128 may indicate to LLM 176 a particular date and/or a particular account in which incremental data entry 120 is associated with instances in which such information is not apparent within image. In one or more embodiments, LLM 176 may receive document representation 152 such as a vector and/or a textual data, wherein LLM 176 may extract important information from document representation 152. In one or more embodiments, generation of document representation 152 may allow for LLM 176 to focus on only relevant information and increase computational efficiency of generating journal entries 164. In one or more embodiments, document representation 152 may represent image 124 within incremental data entry 120. In one or more embodiments, document representation 152 and contextual datum 128 may be input into a large language model. In one or more embodiments, processor 108 may receive the journal entry 164 as an output from the large language model. In one or more embodiments, contextual datum 128 may include a processing request for LLM 176, wherein contextual datum 128 may indicate to LLM 176 how to create journal entry 164. For example, without limitation, contextual datum 128 may indicate that the image 124 within incremental data entry 120 is for a credit received, wherein contextual datum 128 may indicate to LLM 176 that numerical values within incremental data entries 120 should be construed as credits. In one or more embodiments, contextual datum 128 may server as a processing request by indicating to LLM 176 how to process various elements within incremental data entries 120. In one or more embodiments, LLM 176 may be given a template of journal entry 164 containing empty rows and/or columns wherein LLM 176 may be configured to generate journal entry 164 by populating the template with information contained within incremental data entries 120.

With continued reference to FIG. 1, LLM 176 may be configured to compare incremental data entries 120 and/or document representations 152 to an entry threshold 180. An “Entry threshold” for the purposes of this disclosure refers to one or more predetermined requirements needed to generate a journal entry 164. For example, and without limitation, entry threshold 180 may include at least the presence of a numerical value, wherein a journal entry 164 may be of no use without a numerical value. In another non limiting example, entry threshold 180 may include a requirement that incremental data entry 120 contains some sort of indication of whether the numerical value is associated with a credit or debit. Absent such information, journal entry 164 again may be of no use. In one or more embodiments, entry thresholds 180 may include the lack of numerical values, the lack of indication of whether a numerical value is a credit or debit, a lack of a source of revenue and/or the like. In one or more embodiments, entry threshold 180 may include one or more matrix values 168 that must be generated and/or extracted from incremental data entry 120 in order to properly create journal entry 164. In one or more embodiments, large language model may compare the document representation 152 and the contextual datum 128 to an entry threshold 180. In one or more embodiments, a failure of an adherence to one or more entry thresholds 180 may indicate that an incremental data entry 120 requires additional information.

With continued reference to FIG. 1, in one or more embodiments, LLM 176 may be configured to generate and/or transmit a command operation 184 as a function of a comparison between incremental data entry 120 (and/or document representation 152) and entry thresholds 180. A “command operation” for the purposes of this disclosure is instructions for a computer to execute one or more actions. For example, and without limitation command operation 184 may include instructions for processor 108 to request additional information from the user due to a failure of adherence to one more entry thresholds 180. In one or more embodiments, LLM 176 may be configured to instruct processor 108 to display and/or transmit a notification to user that one or more entry thresholds 180 have not been met. For example, and without limitation, a notification may include a prompt on a display device which states “further information is required on whether the financial document relates to a credit or a debit.” In one or more embodiments, command operation 184 may include instructions for processor 108 to execute one or more actions, such as but not limited to, transmit a notification to a user, request additional information from user and/or the like. In one or more embodiments, command operation 184 may include instructions to instantiate a chatbot system 188 on computing device, wherein chatbot system 188 may communicate with user to receive additional information. In one or more embodiments, command operation 184 may include specific instructions for chatbot system 188 to communicate with user and request additional information which may be supplemented within incremental data entry 120 in order to ensure adherence to one or more entry thresholds 180. A “chatbot system” for the purposes of this disclosure is a program configured to simulate human interaction with a user in order to receive or convey information. In some cases, chatbot system 188 may be configured to receive communications from a user and/or elements thereof and any other data as described in this disclosure through interactive questions, presented to the user. In one or more embodiments, chatbot system 188 may be configured to simulate human interaction wherein chatbot system 188 may present questions in a natural language format, wherein the questions are associated with additional information required by the LLM 176. In one or more embodiments, inputs by the user may also be received in a natural language format wherein chatbot system 188 may be configured to convert the inputs into computer languages that can be better understood by LLM 176. In one or more embodiments, chatbot system 188 may be configured to simulate human interaction in a variety of languages based on the preferences of a user. In one or more embodiments, while data processing and/or information received may be in a particular language, chatbot may be configured to translate data based on the preferences of the user. In one or more embodiment, chatbot may be configured to engage in passive data monitoring wherein a user's interactions with chatbot system 188 and/or computing device 104 may be recorded inexplicitly. For example, without limitation, chatbot system 188 may present prompts to a user wherein chatbot system 188 may record the user's reaction time, the user's choice of words, the user's attention to detail in the answers and the like. In one or more embodiments, such interactions may be received as communications. In one or more embodiments, chatbot system 188 may be configured to record actions or behaviors that a user unconsciously exhibits. In one or more embodiments, chatbot system 188 may be configured to communicate information received by user with LLM 176. In one or more embodiments, chatbot system 188 may be configured to receive supplementary information from user, wherein supplementary information may include any information that would be together with incremental data entries 120 in order to generate journal entries 164. In one or more embodiments, command operation 184 may include instructions to instantiate chatbot system 188 through graphical user interface, wherein processor 108 may be configured to modify user interface data structure 144 in order to display chatbot system 188 on graphical user interface. In one or more embodiments, user interface data structure 144 may include code in order to configure remote device 132 to display chatbot system 188 to user. In one or more embodiments, user interface data structure 144 may contain and/or instructions to generate a graphical view and/or visualize graphical elements on remote device, such as but not limited to, images, videos, textual information and/or the like. In one or more embodiments, user interface data structure 144 may include the interface elements such as text boxes, buttons, visual designs and/or the like that the user interacts with. In one or more embodiments, user interface data structure 144 includes chatbot system 188 wherein user interface data structure 144 includes visual and/or interactive elements that allow for a user to communicate with chatbot system 188. In one or more embodiments, user interface data structure 144 may include visual and/or interactive components that allow for a user to seemingly communicate with chatbot system 188. This may include, but is not limited to, chat windows, input fields, buttons, icons and/or the like. In one or more embodiments, user interface data structure 144 may include avatars or icons which may be used to visualize chatbot system 188 on remote device. In one or more embodiments, user interface data structure 144 may include any visual representations that will allow for chatbot system 188 to be visualized on remote device. In one or more embodiments, chatbot system 188 may be located on system, wherein a user may interact with chatbot system 188 through user interface data structure 144. In one or more embodiments, LLM 176 may be configured to generate and transmit command operation 184, wherein command operation 184 may instruct processor 108 to generate a popup window containing chatbot system 188. In one or more embodiments, upon receipt of supplemental information, processor 108 may be configured to terminate the popup window containing chatbot system 188. In one or more embodiments, LLM 176 may communicate directly through chatbot system 188 wherein questions and/or requests by chatbot system 188 may be generated by LLM 176 and responses by a user may be received by LLM 176. In one or more embodiments, command operation 184 may include instructions on what questions chatbot system 188 should ask a user, instructions to instantiate chatbot system 188 and/or a popup window with chatbot system 188 and/or the like.

With continued reference to FIG. 1, in one or more embodiments, command operation 184 may include instruction to transmit a notification to an end user. An “end user” for the purposes of this disclosure refers to an individual other than user who has an interest in the generation of journal entry 164. For example, and without limitation, end user 196 may include an accountant that is responsible for assisting user in the creation of financial documents. In another non limiting example, an end user 196 may include an employer of the user. In one or more embodiments, processor 108 may transmit notification to end user 196 instructing end user 196 that an incremental data entry 120 was not properly received. In one or more embodiments, notifications may be transmitted through SMS, emails and/or through any other electronic communication. In one or more embodiments, notification may allow end user 196 to reply with supplemental information for incremental data entry 120 and/or to modify incremental data entry 120 in order to ensure proper adherence to one or more entry thresholds 180. In one or more embodiments, end user 196 may modify incremental data entry 120 and resubmit incremental data entry 120 for LLM 176 to attempt at creating journal entry 164 again. In one or more embodiments, LLM 176 may be configured to iteratively transmit notifications and/or iteratively communicate with user through chatbot system 188 until one or more entry thresholds 180 are satisfied.

With continued reference to FIG. 1, in one or more embodiments, processor 108 may be configured to generate journal entries 164 using a machine learning model such as any machine learning model as described in this disclosure. In one or more embodiments, the machine learning model may receive incremental data entries 120 and/or document representation 152 as inputs and output journal entries 164. In one or more embodiments, the machine learning model may be trained with training data correlating a plurality of incremental data entries 120 to a plurality of journal entries 164. In one or more embodiments, the machine learning model may be iteratively trained using historical data of previous incremental data entries 120 and correlated journal entries 164. In one or more embodiments, following generation of each journal entry 164, a user may provide feedback on the accuracy of the journal entry 164. In one or more embodiments, such feedback may be used as training data and to train the machine learning model for future iterations. In one or more embodiments, processor 108 and/or LLM 176 may generate a journal entry 164 for each incremental data entry 120 and present each journal entry 164 to user.

With continued reference to FIG. 1, processor 108 is configured to present the one or more journal entries 164 through the graphical user interface for authorization. In one or more embodiments, authorization may include authorization and/or confirmation by a user that the information contained within the journal entry 164 contains the appropriate matrix identifier 172 and the correct matrix value 168. In one or more embodiments, journal entries 164 may be presented though GUI 136 wherein journal entries 164 may be visually displayed through GUI 136 and on a display device. In one or more embodiments, presenting the one or more journal entries 164 through the graphical user interface includes populating the user interface data structure 144 with the one or more matrix values 168 using the one or more matrix identifiers 172 and modifying the graphical user interface as a function of the user interface data structure 144. In one or more embodiments, matrix identifiers 172 may indicate the relative location of matrix values 168 within GUI 136. In one or more embodiments, processor 108 may populate user interface data structure 144 with matrix values 168 using matrix identifiers 172 wherein GUI 136 may correctly present matrix values 168 in their respective location. In one or more embodiments, matrix identifiers 172 may serve as attributes for GUI 136 and/or user interface data structure 144. An “attribute” for the purposes of this disclosure is a piece of data that gives information about something. In one or more embodiments, an attribute may be associated with a “detail” attached to an object. For example and without limitation, attributes associated with matrix values 168 may include colors, themes, font size, location and/or the like. In one or more embodiments, journal entry 164 may include a plurality of attributes such as, but not limited to, particular font sizes, particular colors, particular font selections and/or the like. In one or more embodiments, attributes may include visual attributes such as, but not limited to, size, color, font shape, opacity, alignment and/or the like. In one or more embodiments, attributes may further include interactive attributes which indicate how the user interacts with a user interface. For example, and without limitation, interactive attributes may include clickable elements, draggable elements and/or the like. In one or more embodiments, attributes include properties or characteristics that define the appearance and behavior of interface elements within a user interface. In one or more embodiments, receiving journal entry 164 may include receiving attributes and/or matrix identifiers 172 associated with journal entry 164 and/or matrix values 168.

With continued reference to FIG. 1, user interface data structure 144 may include a plurality of attributes and/or matrix identifiers 172 which define the appearance of chatbot system 188, the location of matrix values 168, the appearance of journal entry 164 and/or the like. In one or more embodiments, user interface data structure 144 may include a plurality of attributes associated with journal entry 164. In one or more embodiments, matrix identifier 172 may include and/or be included an attribute wherein matrix identifier 172 may indicate where matrix values 168 should be located within a window on GUI 136. In one or more embodiments, journal entry 164 may include attributes such as rows, columns, bounding boxes and/or the like, wherein attributes may be used to identify a relative location of matrix values 168 within a row or grid. In one or more embodiments, processor 108 may populate user interface data structure 144 with matrix identifiers 172 and/or matrix values 168 wherein LLM 176 may command GUI 136. In one or more embodiments, Journal entries 164 may include instructions for GUI 136 to display information. In one or more embodiments, LLM 176 may be configured to generate attributes for GUI 136 to display information.

With continued reference to FIG. 1, processor 108 may be configured to construct user interface data structure 144 and/or modify an existing user interface data structure 144 as described above. In one or more embodiments, user interface data structure 144 may include information that may be used to configure remote device 132 to visually display chatbot system 188, journal entry 164 and/or the like on remote device. In one or more embodiments, user interface data structure 144 may be transmitted to remote device, wherein user interface may be displayed on remote device. In one or more embodiments, processor 108 may be configured to configure remote device 132 to generate a graphical view as a function of user interface data structure 144 and journal entries 164. As used in this disclosure, a “graphical view” is a data structure that causes display of one or more graphical elements on a remote device 132 such as remote device. For example, and without limitation, graphical view may include a visual presentation of graphical elements such as images, texts, icons, shapes and/or the like that are displayed to a user on a screen of remote device. In one or more embodiments, graphical elements may include buttons that a user may interact with, textual information and/or the like. In one or more embodiments, graphical view may include information organized within a graphical user interface and configured to facilitate interaction with a graphical user interface. In one or more embodiments, graphical view may include the display of chatbot system 188, the display of journal entry 164 and/or the display of any other information within user interface data structure 144. In one or more embodiments, processor 108 may be configured to configure remote device 132 to generate a graphical view within graphical user interface to display journal entries 164. In one or more embodiments, graphical view may include a single visual representation within an application or system that displays specific graphical elements to the user. In one or more embodiments, graphical view may include any information as described in this disclosure which is structured within a particular format suitable for user interaction. In one or more embodiments, a graphical user interface may include a plurality of graphical views wherein each graphical view may be generated as a function of information generated by processor 108.

With continued reference to FIG. 1, graphical view may include a display element. A “display element,” as used in this disclosure, is an image 124 or set of images that a program or data structure may cause to be displayed on a display of a remote device. Display elements may include, without limitation, windows, pop-up boxes, web browser pages, display layers, and/or any other display element that may occur to a person skilled in the art upon reviewing the entirety of this disclosure. In one or more embodiments, display element may include a virtual avatar, a chatbot system 188 and/or the like. In one or more embodiments, LLM 176 may be configured to generate graphical view and/or display elements through command operations 184. In one or more embodiments, graphical view may include display element wherein graphical view may display virtual avatar and/or chatbot through GUI 136. In one or more embodiments, graphical view may include at least a display element generated as a function of chatbot system 188, journal entry 164 and/or the like. In one or more embodiments, graphical view may further include a first selectable event graphic corresponding to a first selectable event handler. A “selectable event graphic,” as used in this disclosure, is a graphical element that, upon selection, is configured to trigger an action to be performed. In one or more embodiments, selection may de done using a cursor or other locater as manipulated using a locater device such as a mouse, touchscreen, trackpad, joystick and/or the like. As a non-limiting example, a selectable event graphic may include a button or checkbox used to indicate an agreement or an authorization that a particular journal entry 164 is accurate. In one or more embodiments selectable event graphics may include interactive elements that allow a user to select, through a user interface, input fields, text boxes, and/or the like. In one or more embodiments, graphical view may include selectable event graphics that allow a user to interact with GUI 136 in order to authorize one or more journal entries 164 that were generated. In one or more embodiments, selectable event graphics may include input fields representative of matrix values 168 within journal entries 164, wherein a user may select a particular input field. In one or more embodiments, processor 108 may generate selectable event graphics for each input field. In one or more embodiments, selection of an input field may notify processor 108 that a user would like to provide feedback associated with a particular matrix value 168. In one or more embodiments, selection of a selectable event graphic may trigger processor 108 to generate a popup window, a text box and/or the like in which a user may provide feedback.

With continued reference to FIG. 1, selectable event graphic corresponds to a selectable event handler. A “selectable event handler” as described in this disclosure is an event handler associated with selectable event graphic. An “event handler,” as used in this disclosure, is a module, data structure, function, and/or routine that performs an action on remote device 132 in response to a user interaction with selectable event graphic. For instance, and without limitation, an event handler may record data corresponding to user selections of previously populated fields such as drop-down lists and/or text auto-complete and/or default entries, data corresponding to user selections of checkboxes, radio buttons, or the like, potentially along with automatically entered data triggered by such selections, user entry of textual data using a keyboard, touchscreen, speech-to-text program, or the like. In one or more embodiments, event handler may prompt further generation of data following authorization of one or more journal entries 164. Event handler may generate prompts for further information, may compare data to validation rules such as requirements that the data in question be entered within certain numerical ranges, and/or may modify data and/or generate warnings to a user in response to such requirements. Event handler may convert data into expected and/or desired formats, for instance such as date formats, currency entry formats, name formats, or the like. Event handler may transmit data from remote device 132 to computing device 104 and/or processor 108. In one or more embodiments, event handler may allow for interaction by an individual with remote device. In one or more embodiments, an individual such as a user of remote device 132 may interact with remote device 132 to trigger event handler. In one or more embodiments, user interactions with remote device 132 may include, but are not limited to, the inputting of information, interaction with a user interface and/or the like. In one or more embodiments, event handler may cause processor 108 to perform one or more actions in response to user interactions. For example, event handler may cause processor 108 to append journal entries 164 to a general ledger 192 (as described in further detail below). In one or more embodiments, selectable event handler may be triggered upon interaction and/or selection of selectable event graphic. In one or more embodiments, selectable event handler may include instructions to generate data, retrieve data, process information, display information, append journal entries 164 to a particular list and/or the like.

With continued reference to FIG. 1, in one or more embodiments, selectable event handler may be configured to trigger event actions upon interaction of selectable event graphic. An “event action” as described in this disclosure is an operation or set of operations performed by a computing device 104 in response to an event. In one or more embodiments, event action may include the transmission of information to end user 196 to instruct end user 196 that a journal entry 164 has been created. In one or more embodiments, event actions may include notifications that a journal entry 164 has been created and authorized.

With continued reference to FIG. 1, processor 108 is configured to append one or more journal entries 164 to a general ledgers 192 as a function of the authorization. A “general ledger 192” for the purposes of this disclosure is a record of all journal entries 164 created by processor 108. In one or more embodiments, general ledger 192 may include journal entries 164 created on a current or previous iteration of the processing of system 100. In one or more circumstances, general ledger 192 may include itemization of invoices, receipts and/or any other financial transactions. In one or more embodiments, general ledger 192 may include every journal entry 164 generated by system. In one or more embodiments, general ledger 192 may include a matrix, wherein matrix values 168 from journal entry 164 may be appended to the matrix. In one or more embodiments, general ledger 192 may include a matrix that is dynamic in size, wherein general ledger 192 may incrementally increase upon receipt additional journal entries 164. In one or more embodiments, general ledger 192 may serve as a complete record of all financial transaction of a business. In one or more embodiments, general ledger 192 may include an aggregate of all journal entries 164 received. In one or more embodiments, each account in the general ledger 192 may represent a specific category of financial activity, such as, but not limited to, cash, accounts receivable, accounts payable, revenue, expenses and/or the like. In one or more embodiments, incremental data entries 120 may specify which category of financial activity a particular incremental data entry 120 belongs to, wherein general ledger 192 may sort or organize journal entries 164 based on the specific category given. In one or more embodiments, Journal entries 164 may further include the specific category of financial activity that a journal entry 164 belongs to. In one or more embodiments, creation of general ledger 192 may allow for processor 108 to incrementally process data in order to produce a final result. In one or more embodiments, processor 108 may be configured to generate a plurality of general ledgers 192, wherein each general ledger 192 is associated with a particular time period. In one or more embodiments, journal entries 164 corresponding to the particular time period may be appended to the appropriate general ledger 192. In one or more embodiments, the general ledger 192 may shows the cumulative effect of all journal entries 164 on each account. For example, every time a journal entry 164 affects “accounts receivable,” the general ledger 192 may update the balance of that account. Over time, this may create an ongoing record of all financial activity in the business. In one or more embodiments, general ledger 192 may serve as the central repository for all the journal entries 164 and may serve as the foundation for preparing financial statements like the balance sheet and income statement of a business. In one or more embodiments, each journal entry 164 within general ledger 192 may be associated with the same unique identifier 148 of the incremental data entry 120 used to create the respective journal entry 164. In one or more embodiments, unique identifiers 148 may be used to identify a source of each journal entry 164 within general ledger 192. In one or more embodiments, general ledger 192 may contain a database address of each incremental data entry 120. In one or more embodiments, the database address may include an interactive element. In one or more embodiments selection of a particular journal entry 164 within general ledger 192 may instruct processor 108 to retrieve incremental data entry 120 from the particular database address.

With continued reference to FIG. 1, processor 108 may be configured to place general ledger 192 in an immutable state for one or more users upon the occurrence of an event associated with a time element. An “immutable state” for the purposes of this disclosure refers to a condition in which a document or fata file cannot be altered or appended to. In one or more embodiments, immutable state may include instances in which journal entries 164 may no longer be appended to general ledger 192. In one or more embodiments, general ledger 192 may be put in an immutable state only for users, wherein users may no longer submit incremental data entries, such that journal entries 164 are appended to general ledger. In one or more embodiments, processor may place general ledger in an immutable state only for users, wherein end users, such as accountants, employers and/or the like may still make modifications to general ledger 192. In one or more embodiments, processor may make general ledger immutable only for some users, while allowing other users to make changes. In one or more embodiments, users may have unique identification numbers, wherein the processor may make general ledger 192 immutable to some users based on their identification numbers. In one or more embodiments, processor 192 may make general ledger modifiable to other users based on their unique identification numbers, such as for example, users who are accountants, users with higher credentials within a business and/or the like. In one or more embodiments, processor 108 may place general ledger in an immutable state upon the occurrence of an event associated with time element. A time element” for the purposes of this disclosure refers to a date or time associated with general ledger. In one or more embodiments, time element may include the time frame in which journal entries may be appended to general ledger. For example, and without limitation, time element may include January 1 to March 31, wherein journal entries may be appended to general ledger during such a time period. In one or more embodiments, upon the occurrence of an event associated with time element, such as April 1, processor may place general ledger 192 in an immutable state. In one or more embodiments, an event associated with time element may include a new day, a new quarter and/or the like. In one or more embodiments, the occurrence of an event may include the changing of a particular day in the calendar. For example, and without limitation, the occurrence of an event may include a change from March 31 to April 1. In one or more embodiments, time element may correspond to financial quarters of a business, wherein processor may generate a general ledger 192 for each financial quarter. In one or more embodiments, upon the completion of a quarter (also known as an event), processor may place general ledger in an immutable state and generate a new general ledger for journal entries 164. In one or more embodiments, general ledger may be placed in an immutable state, wherein only certain individuals may make changes to general ledger 192. In one or more embodiments, processor 108 may place general ledger in an immutable state by restricting modification of general ledger to only a few individuals. In one or more embodiments, processor may be configured to receive and/or generate a time element for each general ledger, wherein general ledger may be placed in an immutable state upon the occurrence of an event associated with time element. In one or more embodiments, processor may be configured to generate time elements for each general ledger, wherein for example, processor may indicate the general ledger only applies to a particular day, month, quarter, year and/or the like. In one or more embodiments, upon the occurrence of an event as indicate within time element, processor may place general ledger in an immutable state.

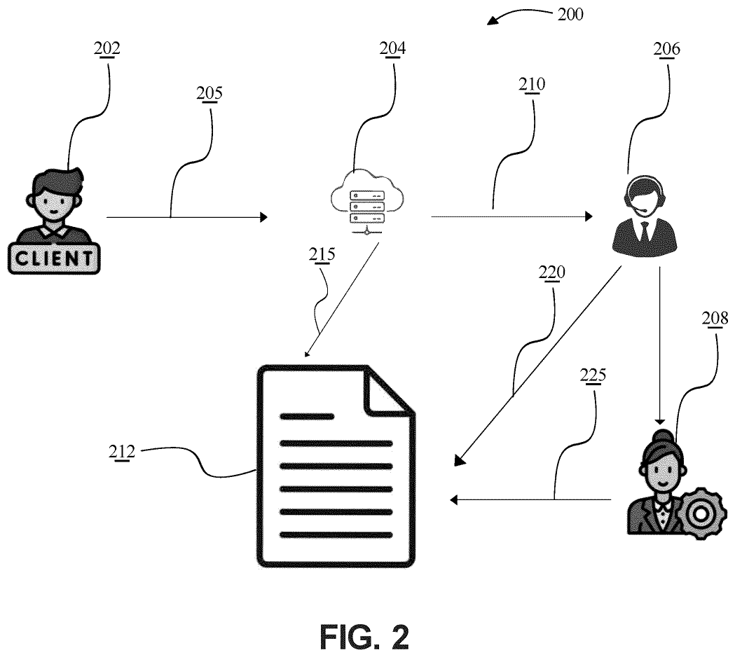

Referring now to FIG. 2, an exemplary flow diagram 200 of a process for generating data files 212 is described. In one or more embodiments, a user 202 facilities a transmission 205 to a computing device 204. In one or more embodiments, transmission 205 may include transmission of incremental data entries. In one or more embodiments, transmission 205 may include the generation of incremental data entries as described above. In one or more embodiments, incremental data entries may be transmitted to computing device 204. In one or more embodiments, computing device 204 may include a server, a remote device, a cloud network and/or the like. In one or more embodiments, computing device 204 may generate 215 a data file. In one or more embodiments, data file 212 may include any journal entry as described in this disclosure. In one or more embodiments, data file 212 may include a unique identifier as described in reference to FIG. 1. In one or more embodiments, data file 212 may include any data generated and/or received as described in reference to FIG. 1. In one or more embodiments, computing device 204 may communicate 210 with a first end user 206. In one or more embodiments, first end user 206 may include an accountant, an employer and/or any end users as described in this disclosure. In one or more embodiments, first end user may generate 220 data file 212. In one or more embodiments, generation 220 of data file 212 may include modification of data file 212. In one or more embodiments, first end user 206 may communicate with a second end user 208 n such as a manager, employer and/or the like. In one or more embodiments, second end user may generate 225 and/or append to data file 212.

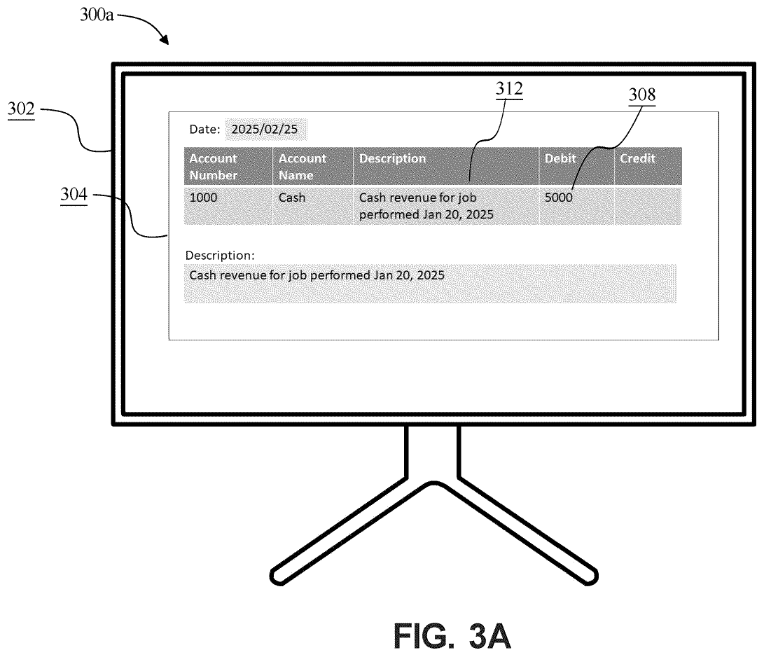

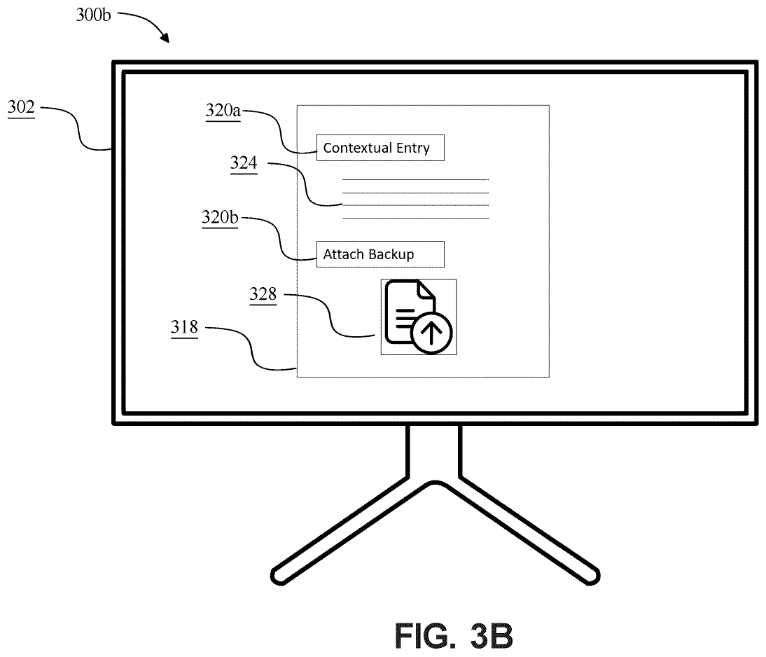

Referring now to FIG. 3A, an exemplary embodiment of a graphical view 300a is described. In one or more embodiments, graphical view 300a may be displayed on a display device 302. In one or more embodiments, display device 302 may include any device and/or remote device as described in this disclosure. In one or more embodiments, graphical view may include a journal entry 304. In one or more embodiments, Journal entry 304 may include any journal entry as described in this disclosure. In one or mor embodiments, journal entry 304 may include matrix values 308. In a non-limiting example, a matrix value 308 as illustrated in FIG. 3 includes numerical values such as ‘1000’, characters such as ‘cash’ and and/or any other information contained within cells 312. In one or more embodiments, graphical view 300a may visualize journal entry in the form of cells 312 and matrix values 308 contained within each cell 312. In one or more embodiments, each cell 312 may contain a relative location. For example, and without limitation, a first cell may contain a location of ‘4×2’ wherein 4×2′ may indicate the fourth column and the second row from a top right starting point. In this instance, ‘4×2’ may include information such as ‘5000’. In one or more embodiments, each cell 312 may contain and/or be associated with a matrix identifier, wherein matrix values 308 may be placed in the cell 312 that is associated with the appropriate matrix identifier. In one or more embodiments, journal entry 304 may be presented through graphical view 300a and/or a GUI, wherein a user may review the generated journal entry 304 and authorize the journal entry 304. In one or more embodiments, journal entry 304 may then be appended to a general ledger containing a plurality of journal entries.

Referring now FIG. 3B, yet another exemplary embodiment of a graphical view 300b is described. In one or more embodiments, graphical view 300b may be configured to display a plurality of information. In one or more embodiments, a computing device as described in reference to at least FIG. 1 may be configured to generate differing, and/or modify existing, graphical views in order to display differing information. In this instance, graphical view 300b may display visual elements in order to receive incremental data entries. In one or more embodiments, graphical view may include an incremental input element 318. In one or more embodiments, incremental input element may include visual elements and/or interactive elements that facilitate the receipt of incremental data entries. In one or more embodiments, incremental input element 318 may include visual elements such as text boxes 320a-b in order to signify the particular type of information required. In one or more embodiments, incremental input element 318 may further include input fields 324 and/or selectable event graphics 328 that allow for the input of information. In one or more embodiments, visual elements may include text boxes 320a-b wherein the text boxes 320a-b may display information corresponding to the type of information that is requested. For example and without limitation, a first text box 320a may display ‘contextual entry’ wherein contextual entry may indicate that a contextual datum is requested. In one or more embodiments, contextual datum may provide context for any images that are received. In one or more embodiments, contextual datum may include textual input describing an image within incremental data entry. In one or more embodiments, graphical view 300b may include an input field 324, that allows for a user to input information through graphical view 300b. In one or more embodiments, input field 324 may allow for a user to input contextual datum to be received by computing device. In one or more embodiments, input field 324 may include an interactive element wherein a user may select input field and interact by inputting information. In one or more embodiments, second text box 320b may display “attach backup” wherein second text box may indicate to a user to attach information such as an image. In one or more embodiments, image may include image of a receipt, an invoice, and/or any other financial documents as described in this disclosure. In one or more embodiments, second text box 320b may indicate to user that user is required to input information. In one or more embodiments, second text box may correspond to a selectable event graphic 328. In one or more embodiments, selectable event graphic may include a visual element such as a display element, that allows for a user to select and interact with. In one or more embodiments, selectable event graphic may correspond to a selectable event handler that instructs computing device to open a new window such that a user may select a data file to input through graphical view. In one or more embodiments, selectable event graphic 328 may allow for a user to attach and/or input an image. In one or more embodiments, a user may select in selectable event graphic, wherein user may be prompted to select an image from a plurality of images on computing device. In one or more embodiments, graphical view 300b may be used to receive incremental data entry from user. In one or more embodiments, incremental data entry may include contextual datum and an image. In one or more embodiments, incremental data entry may be used to generate journal entries. In one or more embodiments, journal entries may be displayed and/or visualized through graphical view 300a.

Referring to FIG. 4, a chatbot system 400 is schematically illustrated. According to some embodiments, a user interface 404 may be communicative with a computing device 408 that is configured to operate a chatbot. In some cases, user interface 404 may be local to computing device 408. Alternatively or additionally, in some cases, user interface 404 may remote to computing device 408 and communicative with the computing device 408, by way of one or more networks, such as without limitation the internet. Alternatively or additionally, user interface 404 may communicate with user device using telephonic devices and networks, such as without limitation fax machines, short message service (SMS), or multimedia message service (MMS). Commonly, user interface 404 communicates with computing device 408 using text-based communication, for example without limitation using a character encoding protocol, such as American Standard for Information Interchange (ASCII). Typically, a user interface 404 conversationally interfaces a chatbot, by way of at least a submission 412, from the user interface 404 to the chatbot, and a response 416, from the chatbot to the user interface 404. In many cases, one or both of submission 412 and response 416 are text-based communication. Alternatively or additionally, in some cases, one or both of submission 412 and response 416 are audio-based communication.

Continuing in reference to FIG. 4, a submission 412 once received by computing device 408 operating a chatbot, may be processed by a processor. In some embodiments, processor processes a submission 412 using one or more of keyword recognition, pattern matching, and natural language processing. In some embodiments, processor employs real-time learning with evolutionary algorithms. In some cases, processor may retrieve a pre-prepared response from at least a storage component 424, based upon submission 412. Alternatively or additionally, in some embodiments, processor communicates a response 416 without first receiving a submission 412, thereby initiating conversation. In some cases, processor communicates an inquiry to user interface 404; and the processor is configured to process an answer to the inquiry in a following submission 412 from the user interface 404. In some cases, an answer to an inquiry present within a submission 412 from a user device may be used by computing device 104 as an input to another function, for example without limitation at least an input to LLM to generate journal entries.

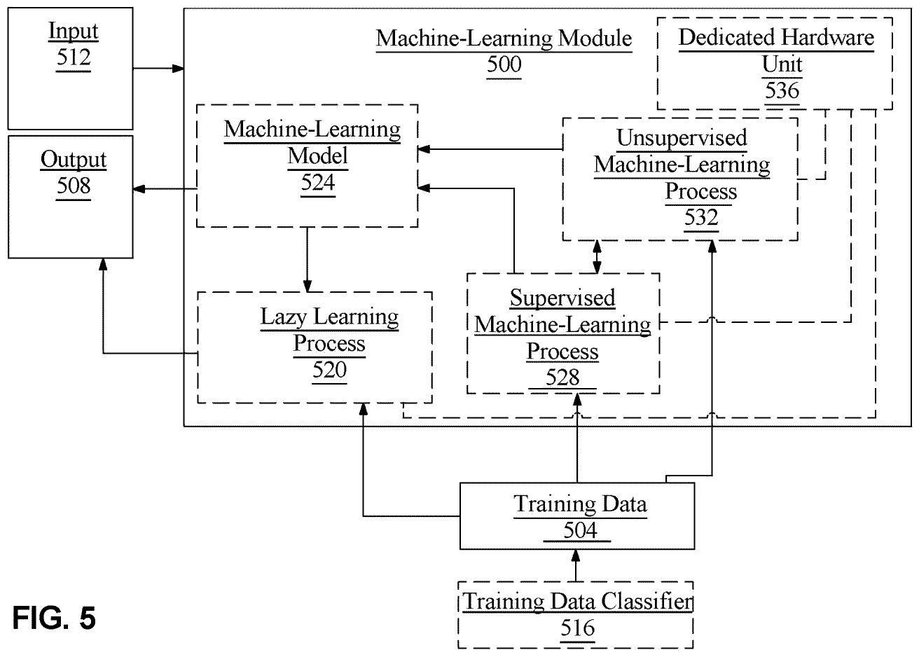

Referring now to FIG. 5, an exemplary embodiment of a machine-learning module 500 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 504 to generate an algorithm instantiated in hardware or software logic, data structures, and/or functions that will be performed by a computing device/module to produce outputs 508 given data provided as inputs 512; this is in contrast to a non-machine learning software program where the commands to be executed are determined in advance by a user and written in a programming language.

Still referring to FIG. 5, “training data,” as used herein, is data containing correlations that a machine-learning process may use to model relationships between two or more categories of data elements. For instance, and without limitation, training data 504 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 504 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 504 according to various correlations; correlations may indicate causative and/or predictive links between categories of data elements, which may be modeled as relationships such as mathematical relationships by machine-learning processes as described in further detail below. Training data 504 may be formatted and/or organized by categories of data elements, for instance by associating data elements with one or more descriptors corresponding to categories of data elements. As a non-limiting example, training data 504 may include data entered in standardized forms by persons or processes, such that entry of a given data element in a given field in a form may be mapped to one or more descriptors of categories. Elements in training data 504 may be linked to descriptors of categories by tags, tokens, or other data elements; for instance, and without limitation, training data 504 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 5, training data 504 may include one or more elements that are not categorized; that is, training data 504 may not be formatted or contain descriptors for some elements of data. Machine-learning algorithms and/or other processes may sort training data 504 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 504 to be made applicable for two or more distinct machine-learning algorithms as described in further detail below. Training data 504 used by machine-learning module 500 may correlate any input data as described in this disclosure to any output data as described in this disclosure. As a non-limiting illustrative example inputs may include inputs such as images and outputs may include data representations.

Further referring to FIG. 5, training data may be filtered, sorted, and/or selected using one or more supervised and/or unsupervised machine-learning processes and/or models as described in further detail below; such models may include without limitation a training data classifier 516. Training data classifier 516 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 500 may generate a classifier using a classification algorithm, defined as a processes whereby a computing device and/or any module and/or component operating thereon derives a classifier from training data 504. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 516 may classify elements of training data to classes of financial information such as for example, images of receipts, images of invoices and/or the like.

Still referring to FIG. 5, a computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device may then calculate a likelihood table by calculating probabilities of different data entries and classification labels. A computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 5, a computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 5, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 5, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. A computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 5, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 5, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 5, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 5, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 5, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 5, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 5, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset Xₘₐₓ:

$${X}_{new} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{new} = \frac{X - {X}_{mean}}{{X}_{max} - {X}_{min}} .$$

Feature scaling may include standardization, where a difference between X and Xₘₑₐₙ is divided by a standard deviation σ of a set or subset of values:

$${X}_{new} = \frac{X - {X}_{mean}}{σ} .$$

Scaling may be performed using a median value of a set or subset X_{median} and/or interquartile range (IQR), which represents the difference between the 25^{th} percentile value and the 50^{th} percentile value (or closest values thereto by a rounding protocol), such as:

$${X}_{new} = \frac{X - {X}_{median}}{IQR} .$$

be aware of various alternative or additional approaches that may be used for feature scaling.

Further referring to FIG. 5, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 5, machine-learning module 500 may be configured to perform a lazy-learning process 520 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 504. Heuristic may include selecting some number of highest-ranking associations and/or training data 504 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 5, machine-learning processes as described in this disclosure may be used to generate machine-learning models 524. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 524 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 524 may be generated by creating an artificial neural network, such as a convolutional neural network comprising an input layer of nodes, one or more intermediate layers, and an output layer of nodes. Connections between nodes may be created via the process of “training” the network, in which elements from a training data 504 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 5, machine-learning algorithms may include at least a supervised machine-learning process 528. At least a supervised machine-learning process 528, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include images as described above as inputs, data representations as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 504. Persons skilled in the art, upon reviewing the entirety of this disclosure, will be aware of various possible variations of at least a supervised machine-learning process 528 that may be used to determine relation between inputs and outputs. Supervised machine-learning processes may include classification algorithms as defined above.

With further reference to FIG. 5, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including, without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 5, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 5, machine learning processes may include at least an unsupervised machine-learning processes 532. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 532 may not require a response variable; unsupervised processes 532 may be used to find interesting patterns and/or inferences between variables, to determine a degree of correlation between two or more variables, or the like.

Still referring to FIG. 5, machine-learning module 500 may be designed and configured to create a machine-learning model 524 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 5, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including, without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 5, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 5, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 5, retraining and/or additional training may be performed using any process for training described above, using any current or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 5, one or more processes or algorithms described above may be performed by at least a dedicated hardware unit 536. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 536 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 536 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 536 to perform one or more operations described herein, such as evaluation of model and/or algorithm outputs, one-time or iterative updates to parameters, coefficients, weights, and/or biases, and/or any other operations such as vector and/or matrix operations as described in this disclosure.

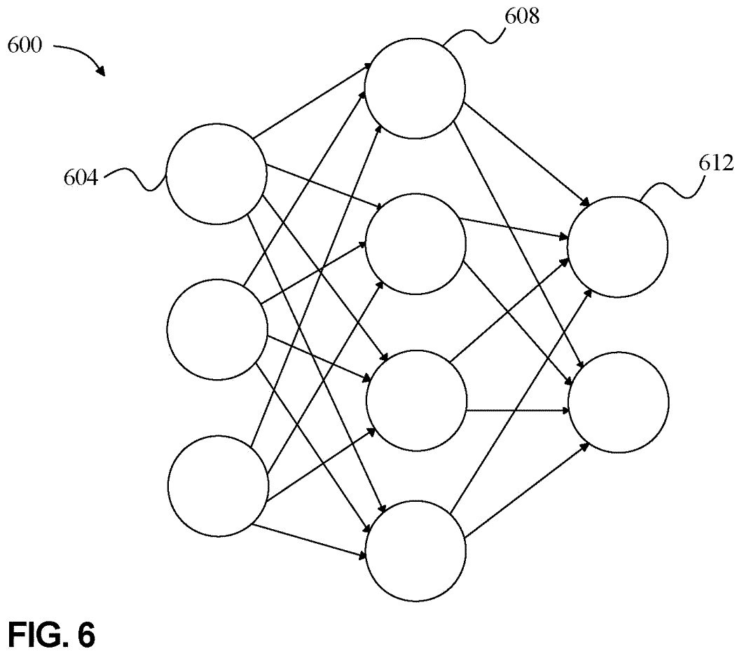

Referring now to FIG. 6, an exemplary embodiment of neural network 600 is illustrated. A neural network 600 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 604, one or more intermediate layers 608, and an output layer of nodes 612. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

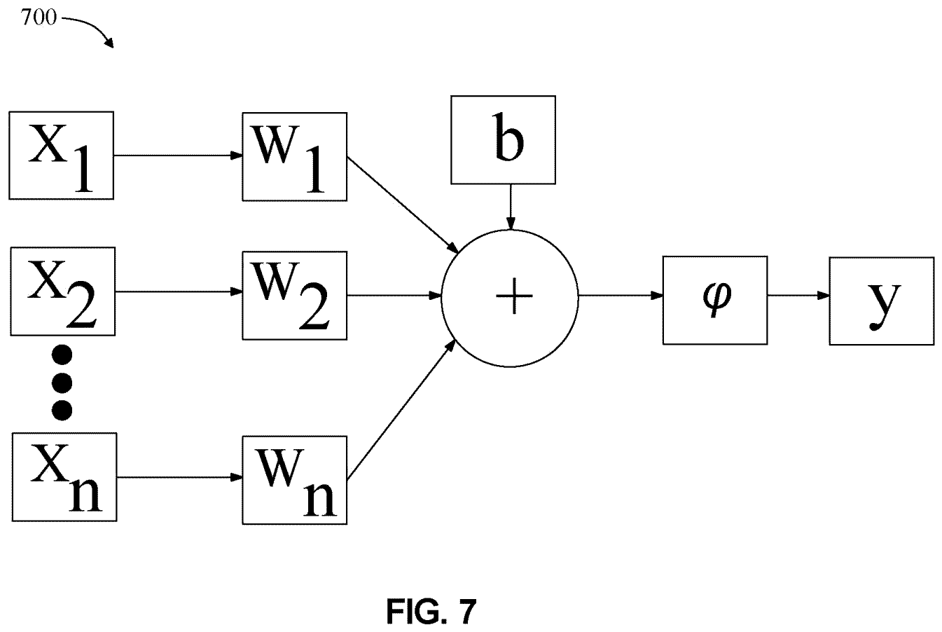

Referring now to FIG. 7, an exemplary embodiment of a node 700 of a neural network is illustrated. A node may include, without limitation, a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as f(x)=tan h²(x), a rectified linear unit function such as f(x)=max(0, x), a “leaky” and/or “parametric” rectified linear unit function such as f(x)=max(ax, x) for some a, an exponential linear units function such as

$$f ( x ) = \{ \begin{matrix}x & for x \geq 0 \\ α ( {e}^{x} - 1 ) & for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as f(x)=x*sigmoid(x), a Gaussian error linear unit function such as f(x)=a(1+tanh(\sqrt{2/π}(x+bx^{r}))) for some values of a, b, and r, and/or a scaled exponential linear unit function such as

$$f ( x ) = λ \{ \begin{matrix}α ( {e}^{x} - 1 ) & for x < 0 \\ x & for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

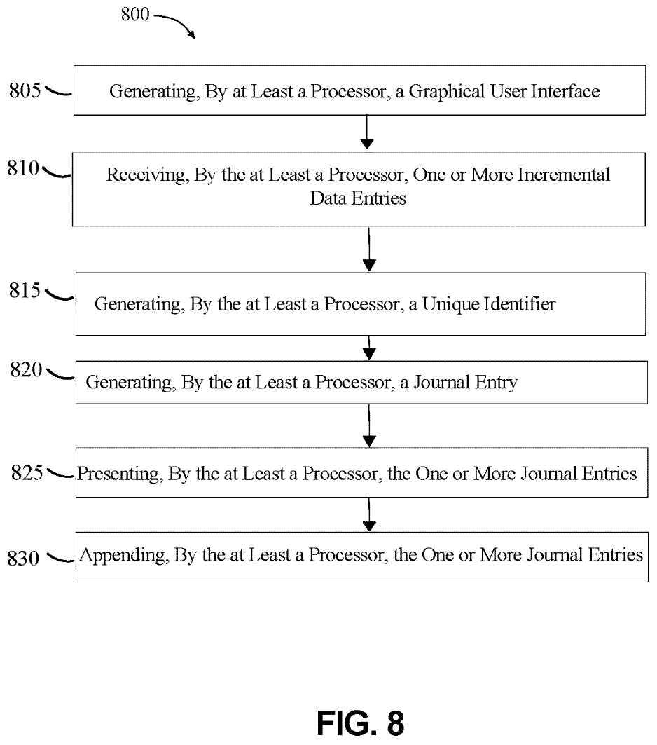

Referring now to FIG. 8, an exemplary method 800 for incremental data processing is described. At step 805, method 800 includes generating, by at least a processor, a graphical user interface including an incremental input element. This may be implemented with reference to FIG. 108 and without limitation.

With continued reference to FIG. 8, at step 810, method 800 includes receiving, by at least a processor, one or more incremental data entries from one or more users through the incremental input element of the graphical user interface. In one or more embodiments, each incremental data entry of the one or more incremental data entries includes at least an image and a contextual datum representative the at least an image, wherein the contextual datum includes a processing request for the at least an image. In one or more embodiments, receiving, by the at least a processor, the one or more incremental data entries from the one or more users through the graphical user interface includes iteratively comparing the one or more incremental data entries to one or more data standard thresholds, iteratively modifying the graphical user interface as a function of the one or more data standard thresholds by displaying at least a datum representative of at least one failure of at least one data threshold of the one or more data standard thresholds and iteratively receiving modified data entries from the one or more users through the graphical user interface until an adherence of the one or more data standard thresholds is satisfied. In one or more embodiments, comparing the one or more incremental data entries to one or more data standard thresholds includes extracting textual data from at least one image within at least one incremental data entry of the one or more incremental data entries and comparing the textual data to the one or more data standard thresholds. This may be implemented with reference to FIGS. 1-8 and without limitation.

With continued reference to FIG. 8, at step 815 method 800 includes generating, by the at least a processor, a unique identifier for each incremental data entry of the one or more incremental data entries. This may be implemented with reference to FIGS. 1-8 and without limitation.

With continued reference to FIG. 8, at step 820 method 800 includes generating, by the at least a processor, a journal entry for each incremental data entry of the one or more incremental data entries wherein each journal entry includes one or more matrix identifiers and one or more associated matrix values. In one or more embodiments, generating, by the at least a processor, the journal entry includes generating a document representation for the at least an image in order to reduce a dimensionality of the at least an image, inputting the document representation and the contextual datum into a large language model and receiving the journal entry as an output from the large language model. In one or more embodiments, inputting the document representation and the contextual datum into the large language model includes comparing, by the large language model, the document representation and the contextual datum to an entry threshold and transmitting a command operation to the processor as a function of the comparison. In one or more embodiments, the command operation includes instructions configuring the at least a processor to instantiate a chatbot system through the graphical user interface. In one or more embodiments, the command operation includes instructions configuring the at least a processor to transmit a notification to an end user. In one or more embodiments, the document representation includes a vector and generating the vector for the at least an image includes receiving representation training data including a plurality of images, generating a plurality of document representations as a function of the document representation training data and a representation machine learning model, calculating a loss of the plurality of document representations and update one or more parameter values of the representation machine learning model as a function of the loss. This may be implemented with reference to FIGS. 1-8 and without limitation.

With continued reference to FIG. 8, at step 825 method 800 includes presenting, by the at least a processor, the one or more journal entries through the graphical user interface for authorization wherein presenting the one or more journal entries through the graphical user interface includes populating, a user interface data structure with the one or more matrix values using the one or more matrix identifiers and modifying the graphical user interface as a function of the user interface data structure. This may be implemented with reference to FIGS. 1-8 and without limitation.

With continued reference to FIG. 8, at step 830 method 800 includes appending, by the at least a processor, the one or more journal entries to a general ledger as a function of the authorization. In one or more embodiments, method 800 may further include, placing by the at least processor, the general ledger in an immutable state for the one or more users upon the occurrence of an event associated with a time element. This may be implemented with reference to FIGS. 1-8 and without limitation.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

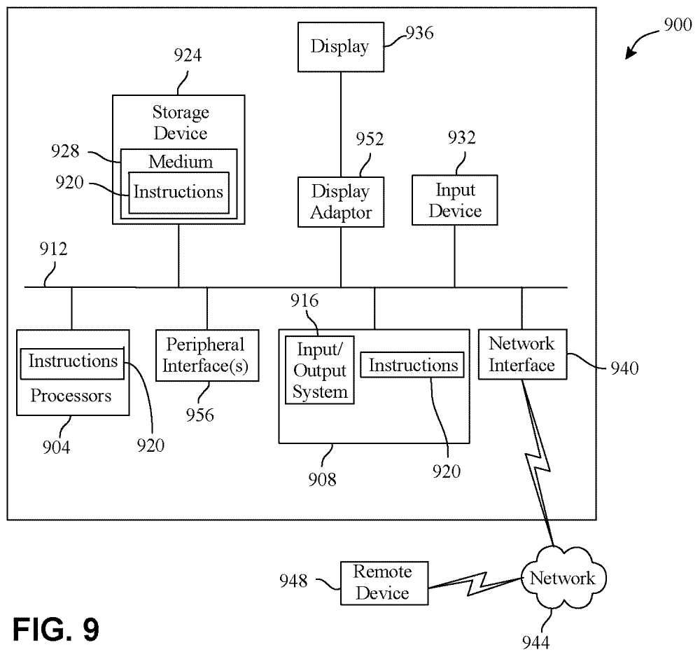

FIG. 9 shows a diagrammatic representation of one embodiment of a computing device in the exemplary form of a computer system 900 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 900 includes a processor 904 and a memory 908 that communicate with each other, and with other components, via a bus 912. Bus 912 may include any of several types of bus structures including, but not limited to, a memory bus, a memory controller, a peripheral bus, a local bus, and any combinations thereof, using any of a variety of bus architectures.

Processor 904 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 904 may be organized according to Von Neumann and/or Harvard architecture as a non-limiting example. Processor 904 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 908 may include various components (e.g., machine-readable media) including, but not limited to, a random-access memory component, a read only component, and any combinations thereof. In one example, a basic input/output system 916 (BIOS), including basic routines that help to transfer information between elements within computer system 900, such as during start-up, may be stored in memory 908. Memory 908 may also include (e.g., stored on one or more machine-readable media) instructions (e.g., software) 920 embodying any one or more of the aspects and/or methodologies of the present disclosure. In another example, memory 908 may further include any number of program modules including, but not limited to, an operating system, one or more application programs, other program modules, program data, and any combinations thereof.

Computer system 900 may also include a storage device 924. Examples of a storage device (e.g., storage device 924) include, but are not limited to, a hard disk drive, a magnetic disk drive, an optical disc drive in combination with an optical medium, a solid-state memory device, and any combinations thereof. Storage device 924 may be connected to bus 912 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 924 (or one or more components thereof) may be removably interfaced with computer system 900 (e.g., via an external port connector (not shown)). Particularly, storage device 924 and an associated machine-readable medium 928 may provide nonvolatile and/or volatile storage of machine-readable instructions, data structures, program modules, and/or other data for computer system 900. In one example, software 920 may reside, completely or partially, within machine-readable medium 928. In another example, software 920 may reside, completely or partially, within processor 904.

Computer system 900 may also include an input device 932. In one example, a user of computer system 900 may enter commands and/or other information into computer system 900 via input device 932. Examples of an input device 932 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 932 may be interfaced to bus 912 via any of a variety of interfaces (not shown) including, but not limited to, a serial interface, a parallel interface, a game port, a USB interface, a FIREWIRE interface, a direct interface to bus 912, and any combinations thereof. Input device 932 may include a touch screen interface that may be a part of or separate from display 936, discussed further below. Input device 932 may be utilized as a user selection device for selecting one or more graphical representations in a graphical interface as described above.

A user may also input commands and/or other information to computer system 900 via storage device 924 (e.g., a removable disk drive, a flash drive, etc.) and/or network interface device 940. A network interface device, such as network interface device 940, may be utilized for connecting computer system 900 to one or more of a variety of networks, such as network 944, and one or more remote devices 948 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 944, may employ a wired and/or a wireless mode of communication. In general, any network topology may be used. Information (e.g., data, software 920, etc.) may be communicated to and/or from computer system 900 via network interface device 940.

Computer system 900 may further include a video display adapter 952 for communicating a displayable image to a display device, such as display 936. Examples of a display device include, but are not limited to, a liquid crystal display (LCD), a cathode ray tube (CRT), a plasma display, a light emitting diode (LED) display, and any combinations thereof. Display adapter 952 and display 936 may be utilized in combination with processor 904 to provide graphical representations of aspects of the present disclosure. In addition to a display device, computer system 900 may include one or more other peripheral output devices including, but not limited to, an audio speaker, a printer, and any combinations thereof. Such peripheral output devices may be connected to bus 912 via a peripheral interface 956. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for generation of a graphical user interface for incremental data processing, the system comprising:
at least a processor; and
a memory communicatively connected to the processor, wherein the memory contains instructions configuring the at least a processor to:
generate a graphical user interface comprising an incremental input element,
receive one or more incremental data entries from one or more users through the incremental input element of the graphical user interface;
generate a unique identifier for each incremental data entry of the one or more incremental data entries;
generate a journal entry for each incremental data entry of the one or more incremental data entries wherein each journal entry comprises one or more matrix identifiers and one or more associated matrix values;
present the one or more journal entries through the graphical user interface for authorization, wherein presenting the one or more journal entries through the graphical user interface comprises:
populating a user interface data structure with the one or more matrix values using the one or more matrix identifiers; and
modifying the graphical user interface as a function of the user interface data structure; and
append the one or more journal entries to a general ledger as a function of the authorization.

2. The system of claim 1, wherein each incremental data entry of the one or more incremental data entries comprises an electronic document.

3. The system of claim 2, wherein generating the journal entry comprises:
generating a document representation for the at least an image in order to reduce a dimensionality of the at least an image;
inputting the document representation and the contextual datum into a large language model; and
receiving the journal entry as an output from the large language model.

4. The system of claim 3, wherein inputting the document representation and the contextual datum into the large language model comprises:
comparing, by the large language model, the document representation and the contextual datum to an entry threshold; and
transmitting a command operation to the processor as a function of the comparison between the document representation and the entry threshold.

5. The system of claim 4, wherein the command operation comprises instructions configuring the processor to instantiate a chatbot system through the graphical user interface.

6. The system of claim 4, wherein the command operation comprises instructions configuring the processor to transmit a notification to an end user.

7. The system of claim 3, wherein:
the document representation comprises a vector and:
wherein generating the vector for the at least an image comprises:
receiving representation training data comprising a plurality of images;
generating a plurality of document representations as a function of the representation training data and a representation machine learning model;
calculating a loss of the plurality of document representations; and
updating one or more parameter values of the representation machine learning model as a function of the loss.

8. The system of claim 1, wherein the processor is further configured to store the one or more incremental data entries on a database.

9. The system of claim 1, wherein receiving the one or more incremental data entries from the one or more users through the graphical user interface comprises:
iteratively comparing the one or more incremental data entries to one or more data standard thresholds;
iteratively modifying the graphical user interface as a function of the one or more data standard thresholds by displaying at least a datum representative of at least one failure of at least one data threshold of the one or more data standard thresholds; and
iteratively receiving modified data entries from the one or more users through the graphical user interface until an adherence of the one or more data standard thresholds is satisfied.

10. The system of claim 1, wherein the processor is further configured to place the general ledger in an immutable state for the one or more end users upon the occurrence of an event associated with a time element.

11. A method for generation of a graphical user interface for incremental data processing, the method comprising:
generating, by at least a processor, a graphical user interface comprising an incremental input element;
receiving, by at the least a processor, one or more incremental data entries from one or more users through the incremental input element of the graphical user interface;
generating, by the at least a processor, a unique identifier for each incremental data entry of the one or more incremental data entries;
generating, by the at least a processor, a journal entry for each incremental data entry of the one or more incremental data entries wherein each journal entry comprises one or more matrix identifiers and one or more associated matrix values;
presenting, by the at least a processor, the one or more journal entries through the graphical user interface for authorization wherein presenting the one or more journal entries through the graphical user interface comprises:
populating, a user interface data structure with the one or more matrix values using the one or more matrix identifiers; and
modifying the graphical user interface as a function of the user interface data structure; and
appending, by the at least a processor, the one or more journal entries to a general ledger as a function of the authorization.

12. The method of claim 11, wherein each incremental data entry of the one or more incremental data entries comprises an electronic document.

13. The method of claim 12, wherein generating, by the at least a processor, the journal entry comprises:
generating a document representation for the at least an image in order to reduce a dimensionality of the at least an image;
inputting the document representation and the contextual datum into a large language model; and
receiving the journal entry as an output from the large language model.

14. The method of claim 13, wherein inputting the document representation and the contextual datum into the large language model comprises:
comparing, by the large language model, the document representation and the contextual datum to an entry threshold; and
transmitting a command operation to the processor as a function of the comparison between the document representation and the entry threshold.

15. The method of claim 14, wherein the command operation comprises instructions configuring the at least a processor to instantiate a chatbot system through the graphical user interface.

16. The method of claim 14, wherein the command operation comprises instructions configuring the at least a processor to transmit a notification to an end user.

17. The method of claim 13, wherein:
the document representation comprises a vector and:
wherein generating the vector for the at least an image comprises:
receiving representation training data comprising a plurality of images;
generating a plurality of document representations as a function of the representation training data and a representation machine learning model;
calculating a loss of the plurality of document representations; and
updating one or more parameter values of the representation machine learning model as a function of the loss.

18. The method of claim 11, further comprising, storing, by the at least a processor, the one or more incremental data entries on a database.

19. The method of claim 11, wherein receiving, by the at least a processor, the one or more incremental data entries from the one or more users through the graphical user interface comprises:
iteratively comparing the one or more incremental data entries to one or more data standard thresholds;
iteratively modifying the graphical user interface as a function of the one or more data standard thresholds by displaying at least a datum representative of at least one failure of at least one data threshold of the one or more data standard thresholds; and
iteratively receiving modified data entries from the one or more users through the graphical user interface until an adherence of the one or more data standard thresholds is satisfied.

20. The method of claim 11, the method further comprising placing, by the at least a processor, the general ledger in an immutable state for the one or more end users upon the occurrence of an event associated with a time element.
